(19) United States
(12) Patent Application Publication
(10) Pub. No.: US 2020/0338464 A1
(43) Pub. Date: Oct. 29, 2020

(54) SELF-GUIDED RACE CAR KIT AND RACE TRACK

(71) Applicant: Robomotive Laboratories LLC, Cincinnati, OH (US)

(72) Inventor: Brett J. Pipitone, Cincinnati, OH (US)

(73) Assignee: Robomotive Laboratories LLC, Cincinnati, OH (US)

(21) Appl. No.: 16/857,842

(22) Filed: Apr. 24, 2020

Related U.S. Application Data
(60) Provisional application No. 62/839,188, filed on Apr. 26, 2019.

(51) Int. Cl. A63H 17/395; A63H 18/02; A63H 17/26; G05D 1/02

(52) U.S. Cl. CPC A63H 17/395; A63H 18/023; G05D 1/0246; G05D 1/0234; A63H 17/262

(57) ABSTRACT

An unpowered downhill autonomous car kit is provided for a user to build. The kit includes a control circuit board, a servo, and a roadway detection sensor. The control circuit board is programmed by a user to interpret patterns marked on a race course that are detected by the roadway detection sensor, and then the control circuit board instructs the servo to steer the car based on the detected roadway patterns. The challenge is for the user to program the car kit in a manner such that during a race, the car will avoid vertical barriers on the race course by correctly interpreting the patterns viewed by the roadway detection sensor. The roadway patterns are intentionally not consistent as the car moves from one roadway segment to the next, so as to increase the technical challenge.

### CROSS-REFERENCE TO RELATED APPLICATIONS

The present application claims priority to provisional patent application Ser. No. 62/839,188, titled “SELF-GUIDED RACE CAR KIT AND RACE TRACK,” filed on Apr. 26, 2019.

### TECHNICAL FIELD

The technology disclosed herein relates generally to car kits, and is particularly directed to downhill car kits which can detect patterns on a race course (i.e., markings on a roadway surface) and uses an externally programmed circuit board to steer the car based on the detected patterns to avoid hitting vertical barriers. Embodiments are specifically disclosed as a downhill autonomous car kit having a control circuit board, a servo, and a roadway detection sensor.

The control circuit board is programmed by a user (the kit builder). Feedback from roadway detection sensor determines what direction the car should steer, and that direction is translated to the servo, which controls the front axle and thus “steers” the car.

The patterns on the race course can be varied to provide a programming, and racing, challenge to the kit builder. The patterns include various stripes or lines in the direction of travel of the car, and some stripes or lines are transverse to the direction of travel of the car. Other types of roadway markings, such as non-linear road surface indicia, could also be used on a given race course, including corners.

More than one level of difficulty is available for use with the autonomous race car kit disclosed herein. For example, a ‘Level 1’ car can have a first type of optical sensor suite and can have a simplified programming arrangement, for use by very young users. A ‘Level 2’ race car can have a second type of optical sensor, such as a digital camera, and can have a more advanced programming arrangement, for use by older children as users. A ‘Level 3’ race car can have a combination of types of optical sensors, requiring yet more advanced programming capabilities, for yet older children as users.

### STATEMENT REGARDING FEDERALLY SPONSORED RESEARCH OR DEVELOPMENT

None.

### BACKGROUND

STEM (science, technology, engineering, mathematics) education is gaining importance in school systems across the world. A need for innovative and relevant STEM competitions exist. While numerous STEM competitions have been established, there is as yet no accessible downhill autonomous racer competition. This disclosure provides a downhill racer kit for use in a STEM competition.

### SUMMARY

Accordingly, it is an advantage to provide a downhill autonomous car kit with a floorboard having evenly spaced holes, such that the various parts of the car kit can be mounted wherever the kit builder desires.

It is another advantage to provide a downhill autonomous car kit with a control circuit board, an output actuator (such as a servo), and roadway detection sensors, so that the kit builder can program the control circuit board to respond to feedback from roadway detection sensors, such that the feedback is translated into steering instructions sent to the servo, which then produces mechanical movements to steer the car based on those steering instructions.

It is yet another advantage to provide a race course for a downhill autonomous car kit, with patterns of stripes and lines (or other markings) on the roadway surface, so that the car kit may be programmed by the kit builder to steer the car based on detecting and interpreting those visible patterns that appear on the race course.

It is a further advantage to provide a system for programming a downhill autonomous race car that includes multiple difficulty levels for controlling the steering movements of the race car, using different sensor packages for different difficulty levels, so that users of various age groups will be appropriately challenged.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, an unpowered autonomous car kit is provided, which comprises: (a) a floorboard having a plurality of mounting holes, the floorboard extending between a first end and a second, opposite end, and having a longitudinal axis between the first and second ends; (b) a circuit board secured to the floorboard using at least one fastener at the plurality of mounting holes in the floorboard, the circuit board including a processing circuit, a memory circuit, and an input/output interface circuit; (c) a servo secured to the floorboard using at least one fastener, the servo being mounted in a low profile orientation with respect to the frontal cross-sectional area of the car, the servo having a movable output shaft that extends in a transverse direction with respect to the longitudinal axis, and having a movable servo arm that is mounted to the output shaft; (d) a steerable front axle secured to the floorboard using at least one fastener, mounted proximal to the first end of the floorboard; (e) a servo control rod that extends between the servo arm and the steerable front axle; (f) at least one roadway detection sensor secured to the floorboard using at least one fastener; (g) a rear axle secured to the floorboard using at least one fastener, mounted proximal to the second end of the floorboard; and (h) a plurality of wheels mounted on the front axle and the rear axle.

In accordance with another aspect, a raceway for use with autonomous guidance vehicles is provided, which comprises: (a) a plurality of roadway portions that are mounted next to one another to form a continuous racing surface that includes a start line portion and a finish line portion, along a direction of racing; (b) the raceway exhibiting a distance of a predetermined length between the start line and the finish line that determines a raceway course; (c) the raceway having at least one lane for an autonomous guidance vehicle to travel on, the elevation of the raceway between the start line and the finish line being generally downward sloping in a direction of racing, such that the continuous racing surface exhibits at least one change of slope in the direction of racing, in which the start line is at a higher elevation than the finish line; and (d) the plurality of roadway portions exhibits different predetermined patterns of visible markings on different individual portions of the racing surface.

In accordance with yet another aspect, a method for building an unpowered autonomous car kit is provided, in which the method comprises the following steps: (a) providing a floorboard with a plurality of mounting holes, the floorboard having a longitudinal axis between a first end and a second end; (b) providing a circuit board, and securing the circuit board to the floorboard through the mounting holes with fasteners; (c) providing a servo, and securing the servo to the floorboard with fasteners; (d) providing a front axle, and securing the front axle to the floorboard proximal to the first end through the mounting holes with fasteners; (e) providing a roadway detection sensor subassembly, and securing the detection sensor subassembly to the floorboard through the mounting holes with fasteners; (f) providing a rear axle, and securing the rear axle to the floorboard through a groove, proximal to the second end of the floorboard; and (g) mounting wheels to the front axle and the rear axle.

In accordance with still another aspect, a raceway for use with autonomous guidance vehicles is provided, which comprises: (a) a plurality of roadway portions that are mounted next to one another to form a continuous racing surface that includes a start line portion and a finish line portion, along a direction of racing; (b) the raceway exhibiting a distance of a predetermined length between the start line and the finish line that determines a raceway course; (c) the raceway having at least one lane for an autonomous guidance vehicle to travel on; and (d) the plurality of roadway portions exhibits different predetermined patterns of visible markings on different individual portions of the racing surface.

In accordance with a further aspect, a race car kit is provided which comprises: a chassis, at least one steerable wheel, a processing circuit, a memory circuit including instructions executable by the processing circuit, an input/output interface circuit, an output actuator for controlling the at least one steerable wheel, and at least one roadway detection sensor; wherein: the processing circuit is configured to execute the instructions stored in the memory circuit; and wherein: (a) instructions stored in the memory circuit includes a first algorithm for controlling the output actuator in a first level of programming difficulty; and (b) the memory circuit includes physical memory elements for storing a user-defined second algorithm for controlling the output actuator in a second level of programming difficulty.

In accordance with a yet further aspect, a race car kit is provided which comprises: a chassis, at least one steerable wheel, a processing circuit, a memory circuit including instructions executable by the processing circuit, an input/output interface circuit which includes a communications interface circuit, an output actuator for controlling the at least one steerable wheel, and at least one roadway detection sensor; wherein: (a) the processing circuit is configured to execute the instructions stored in the memory circuit; and (b) the instructions stored in the memory circuit include at least one of: (i) a first algorithm for controlling the output actuator involving a first level of programming difficulty, such that: (A) at least one predetermined type of input parameter is provided by a user by use of the communications interface circuit, and stored in the memory circuit; (B) the first algorithm controls the acquisition of sensor data and, using the at least one user-provided input parameter, controls the output actuator; and (ii) a second algorithm for controlling the output actuator involving a second, more difficult level of programming difficulty, such that: (A) the second algorithm is provided by a user by use of the communications interface circuit, and stored in the memory circuit; and (B) the second algorithm controls the acquisition of sensor data and, by itself, controls the output actuator.

In accordance with a still further aspect, a race car kit is provided, which comprises: a chassis, at least one steerable wheel, a processing circuit, a memory circuit including instructions executable by the processing circuit, an input/output interface circuit, an output actuator for controlling the at least one steerable wheel, and at least one roadway detection sensor; wherein: (a) the processing circuit is configured to execute the instructions stored in the memory circuit, and the instructions stored in the memory circuit involve a level of programming difficulty from at least two possible levels of programming difficulty, such that a first algorithm is provided for a first level of programming difficulty and a second algorithm is provided for a second level of programming difficulty; (b) the first algorithm stored in the memory circuit is used for controlling the output actuator, based on input data received from a first type of the at least one roadway detection sensor; and (c) the second algorithm stored in the memory circuit is used for controlling the output actuator, based on input data received from a second type of the at least one roadway detection sensor.

In accordance with an even further aspect, a method for building an unpowered autonomous car kit is provided, in which the method comprises the following steps: (a) providing a floorboard with a plurality of mounting holes, the floorboard having a longitudinal axis between a first end and a second end; (b) providing a circuit board, and securing the circuit board to the floorboard through the mounting holes with fasteners, the circuit board including a processing circuit, a memory circuit, and an input/output interface circuit; (c) providing an output actuator, and securing the output actuator to the floorboard with fasteners, the output actuator having a movable output shaft; (d) providing a front axle, and securing the front axle to the floorboard proximal to the first end through the mounting holes with fasteners; (e) connecting the output shaft to the front axle, such that movements of the output shaft cause steering movements of the front axle; (f) providing a roadway detection sensor subassembly, and securing the detection sensor subassembly to the floorboard through the mounting holes with fasteners; (g) providing a rear axle, and securing the rear axle to the floorboard through a groove, proximal to the second end of the floorboard; and (h) mounting wheels to the front axle and the rear axle.

In accordance with an additional aspect, an unpowered autonomous car kit is provided, which comprises: (a) a floorboard having a plurality of mounting holes, the floorboard extending between a first end and a second, opposite end, and having a longitudinal axis between the first and second ends; (b) a circuit board secured to the floorboard using at least one fastener at the plurality of mounting holes in the floorboard, the circuit board including a processing circuit, a memory circuit, and an input/output interface circuit; (c) a steerable front axle secured to the floorboard using at least one fastener, mounted proximal to the first end of the floorboard; (d) an output actuator secured to the floorboard using at least one fastener, the output actuator having a movable output shaft that extends to the front axle; (e) at least one roadway detection sensor secured to the floorboard using at least one fastener; (f) a rear axle secured to the floorboard using at least one fastener, mounted proximal to the second end of the floorboard; and (g) a plurality of wheels mounted on the front axle and the rear axle.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a front perspective view of a car kit, showing the floorboard and the circuit board fastened in a first position, as constructed according to the principles of the technology disclosed herein.

FIG. 2 is a front perspective view of the floorboard of the car kit of FIG. 1, showing the main circuit board fastened in a second, different, position.

FIG. 3 is a front perspective view of the front axle of the car kit of FIG. 1, showing a flat position, and a bent position.

FIG. 4 is a front perspective view of the floorboard of the car kit of FIG. 1, showing the front axle, servo, and wheels all fastened to the floorboard.

FIG. 5A is a front perspective view of the floorboard of the car kit of FIG. 1, showing the front axle, wheels, and the line following circuit board (with sensors) all fastened to the floorboard.

FIG. 5B is a bottom perspective view of the floorboard of the car kit of FIG. 1, showing the front axle, wheels, and the line following circuit board all fastened to the floorboard.

FIG. 6 is a front perspective view of the camera mount of the car kit of FIG. 1, showing a flat position, and a bent position.

FIG. 7A is a front perspective view from above of the floorboard of the car kit of FIG. 1, showing the front axle, wheels, the camera mount, and the camera all fastened to the floorboard.

FIG. 7B is a front perspective view from below of the floorboard of the car kit of FIG. 1, showing the front axle, wheels, the camera mount, and the camera all fastened to the floorboard.

FIG. 8A is a first line arrangement on the race surface, as constructed according to the principles of the technology disclosed herein.

FIG. 8B is a second line arrangement on the race surface, as constructed according to the principles of the technology disclosed herein.

FIG. 8C is a third line arrangement on the race surface, as constructed according to the principles of the technology disclosed herein.

FIG. 8D is a fourth line arrangement on the race surface, as constructed according to the principles of the technology disclosed herein.

FIG. 8E is a fifth line arrangement on the race surface, as constructed according to the principles of the technology disclosed herein.

FIG. 8F is a sixth line arrangement on the race surface, as constructed according to the principles of the technology disclosed herein.

FIG. 8G is a seventh line arrangement on the race surface (showing no thick stripes), as constructed according to the principles of the technology disclosed herein.

FIG. 9 is a front perspective view of a portion of the race course, as constructed according to the principles of the technology disclosed herein.

FIG. 10 is a front perspective view from above of the car kit of FIG. 1, showing an alternative position for the camera mount.

FIG. 11 is a front perspective view from above of the car kit of FIG. 1, showing an example of the entire car with its upper bodywork installed.

FIG. 12 is a block diagram of the major components of a general-level electronic circuit used in the car kit of FIG. 1, particularly indicating some of the sensors and a control output that are connected to a processing circuit, as constructed according to the principles of the technology disclosed herein.

FIG. 13 is a diagrammatic view of a display screen for use in programming a Level 1 race car kit, such as for the car kit of FIG. 1 that incorporates certain sensors.

FIG. 14 is a block diagram of the major electronic hardware components of a Level 1 race car kit, as constructed according to the principles of the technology disclosed herein, and including the computer system used for programming the on-board software that is to be used by the processing circuit of the race car kit.

FIG. 15 is a flow chart/logic diagram of some of the important steps performed by the on-board control software used in a Level 1 race car kit, such as for the car kit of FIG. 1 that incorporates certain sensors.

FIG. 16 is a diagrammatic view of a display screen for use in programming a Level 2 race car kit, such as for the car kit of FIG. 1 that incorporates certain sensors.

FIG. 17 is a block diagram of the major electronic hardware components of a Level 2 race car kit, as constructed according to the principles of the technology disclosed herein, and including the computer system used for programming the on-board software that is to be used by the processing circuit of the race car kit.

FIG. 18 is a flow chart/logic diagram of some of the important steps performed by the on-board control software used in a Level 2 race car kit, such as for the car kit of FIG. 2 that incorporates certain sensors.

FIG. 19 is a block diagram of the major electronic hardware components of a Level 3 race car kit, as constructed according to the principles of the technology disclosed herein, and including the computer system used for programming the on-board software that is to be used by the processing circuit of the race car kit.

FIG. 20 is a flow chart/logic diagram of some of the important steps performed by the on-board control software used in a Level 3 race car kit, such as for the car kit of FIG. 3 that incorporates a suite of sensors.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, the terms “communicating with” and “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” and “second” preceding an element name, e.g., first inlet, second inlet, etc., are used for identification purposes to distinguish between similar or related elements, results or concepts, and are not intended to necessarily imply order, nor are the terms “first” and “second” intended to preclude the inclusion of additional similar or related elements, results or concepts, unless otherwise indicated.

In addition, it should be understood that embodiments disclosed herein include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the technology disclosed herein may be implemented in software. As such, it should be noted that a plurality of hardware and software-based devices, as well as a plurality of different structural components may be utilized to implement the technology disclosed herein. Furthermore, if software is utilized, then the processing circuit that executes such software can be of a general purpose computer, while fulfilling all the functions that otherwise might be executed by a special purpose computer that could be designed for specifically implementing this technology.

It will be understood that the term “circuit” as used herein can represent an actual electronic circuit, such as an integrated circuit chip (or a portion thereof), or it can represent a function that is performed by a processing circuit, such as a microprocessor or an ASIC that includes a logic state machine or another form of processing element (including a sequential processing circuit). A specific type of circuit could be an analog circuit or a digital circuit of some type, although such a circuit possibly could be implemented in software by a logic state machine or a sequential processor. In other words, if a processing circuit is used to perform a desired function used in the technology disclosed herein (such as a demodulation function), then there might not be a specific “circuit” that could be called a “demodulation circuit;” however, there would be a demodulation “function” that is performed by the software. All of these possibilities are contemplated by the inventors, and are within the principles of the technology when discussing a “circuit.”

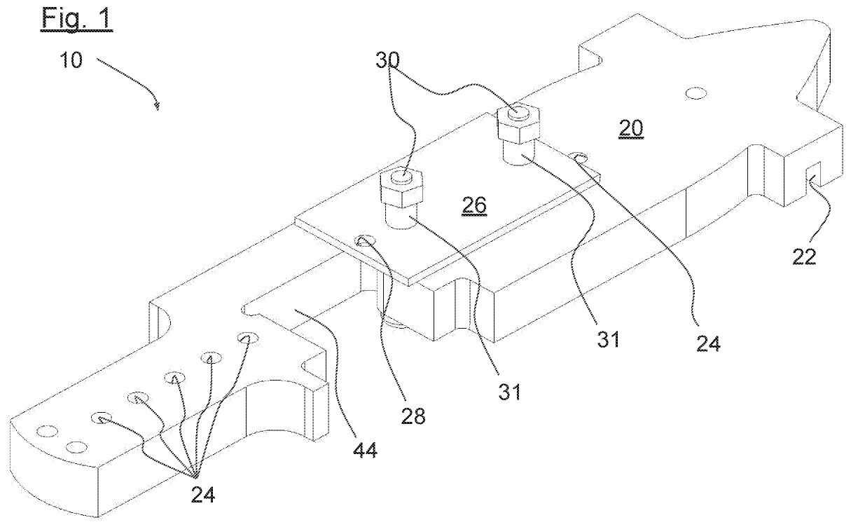

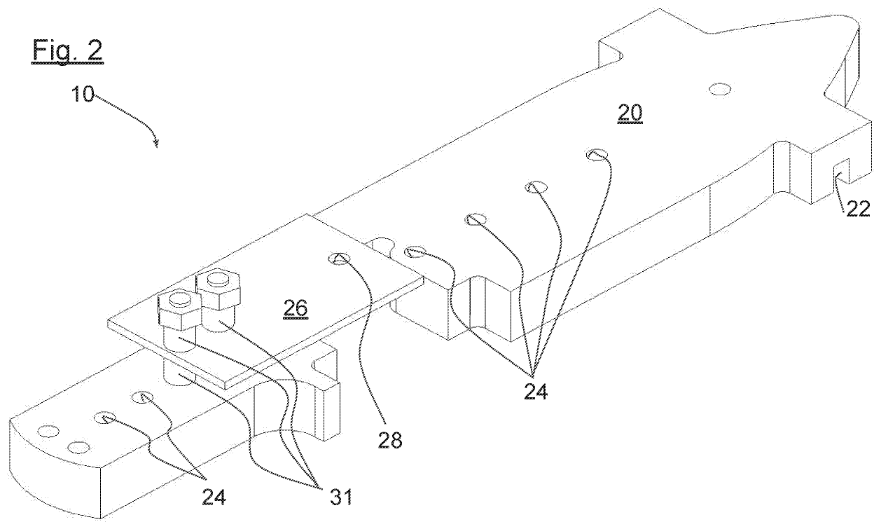

Referring now to FIG. 1, an exemplary embodiment of an “unpowered” downhill autonomous car kit is generally designated by the reference numeral 10. (Note that, as used herein, the word “unpowered” means that the car has no propulsion system, and therefore, requires gravity and a downhill road surface for initial movement; however, the car does include a power source for a guidance system.) The car kit 10 includes a floorboard 20, which includes a rear groove 22, and a plurality of spaced-apart holes 24. The plurality of holes 24 may be evenly spaced, and they allow a user, or kit builder, to mount the various components of the car kit 10 to the floorboard in various configurations. A cutout 44 on the outer mold line (“OML”) of the floorboard 20 is provided so that a servo 46 may be installed. A circuit board 26, including mounting holes 28, is shown installed to the rear (in this view) of the cutout 44, in a first configuration. The circuit board 26 is secured using fasteners 30, such as screws or nuts and bolts. FIG. 2 illustrates spacers 31 mounted in a direct line beneath the fasteners 30. These optional spacers 31 are used to provide room beneath the circuit board 26 for other kit components (see below).

It will be understood that the servo 46 is only one example of a type of rotary ‘output actuator.’ For this product, a different type of output actuator could be used for controlling the steering, such as a linear displacement actuator. In this detailed description, the word ‘servo’ will be used throughout as a preferred example of an output actuator that is used for this specific function, with the understanding that many other types of steering controls could instead be used. As a further example, if a linear displacement actuator is used, its output shaft could be directly attached to the front axle to control the steering of the race car. The mechanical gain would then be adjustable by changing which mounting hole in the front axle is used to connect with the linear actuator's output shaft.

Referring now to FIG. 2, the car kit 10 is shown including the floorboard 20, having the rear groove 22, and the plurality of spaced-apart holes 24. However, the circuit board 26 is mounted to the front (in this view) of the cutout, in a second configuration. The circuit board 26 is again secured using fasteners 30. FIG. 2 illustrates spacers 31 mounted in a direct line beneath the fasteners 30. As noted above, these optional spacers 31 are used to provide room beneath the circuit board 26 for other kit components (see below).

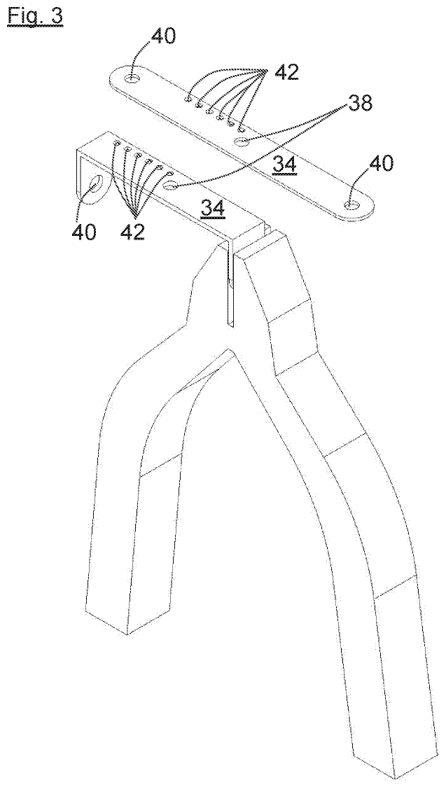

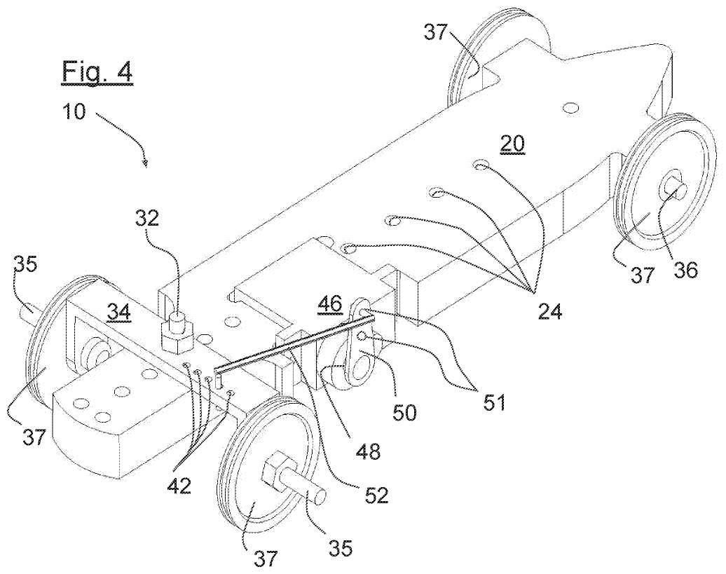

Referring now to FIG. 3, a front axle 34 is shown in two configurations. The first configuration of the front axle 34 is flat, and the second configuration is bent. The front axle 34 may be provided as a flat piece, so that the kit builder can bend the front axle 34 in various angles. This configurability of the front axle 34 gives the kit builder an additional building challenge when constructing the car kit 10. The front axle 34 includes two end holes 40 for wheels 37 (see FIG. 4), a center hole 38 to mount the front axle 34 to the floorboard 20, and a plurality of servo connection holes 42. The servo connection holes 42 will be discussed in greater detail below.

Referring now to FIG. 4, the car kit 10 is shown, including the floorboard 20, the front axle 34, and the plurality of spaced-apart holes 24. The front axle 34 is shown secured to the floorboard 20 by a screw or other fastener 32. The wheels 37, are secured to the front axle 34 by fasteners, such as screws 35. The wheels 37 are also shown on the rear axle 36. A hobby servo (e.g., a micro servo) 46 is installed in the floorboard cutout 44. Thus, the servo does not sit on the floorboard, but instead, there is a special opening 44 in the floorboard 20 that allows the servo to be mounted at the same elevation as the floorboard (rather than strictly above the floorboard). This arrangement of components, therefore, reduces the cross-sectional frontal area of the car, once fully assembled.

The servo 46 includes a protruding servo spline 48 (as a mechanical output shaft), a vertical servo arm 50 attached to the spline 48, and a servo link 52 attached to the vertical arm 50. FIG. 4 illustrates the servo link 52 attached to the front axle 34 in one of the servo holes 42. It will be understood that the servo link 52 may be attached to any of the front axle servo connection holes 42. The kit builder's choice of servo connection hole 42 to use will determine the mechanical gain of the car 10. It should be noted that the servo arm 50 may have multiple holes 51 through which the servo link 52 may attach, and the kit builder's choice of which servo arm hole 51 to use will also determine the mechanical gain of the car 10 (not shown in FIG. 4).

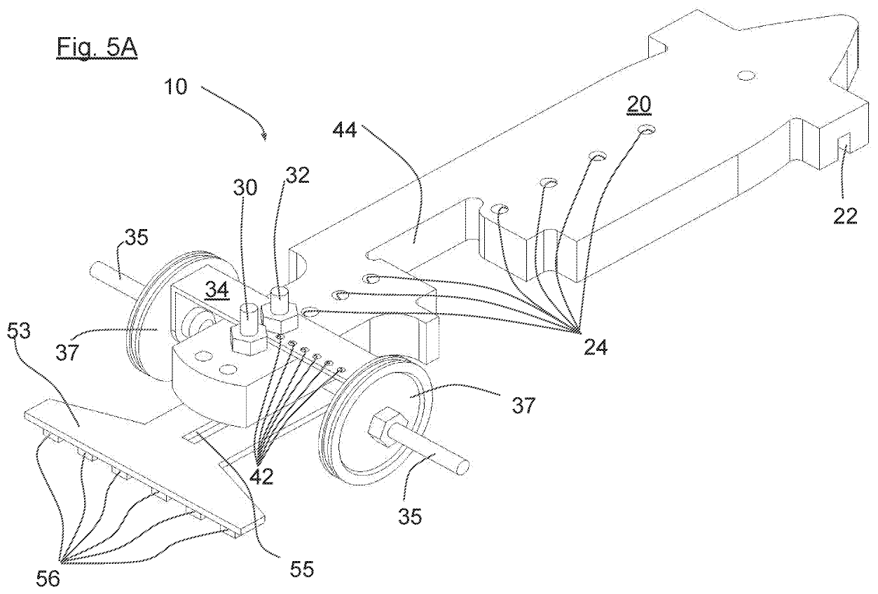

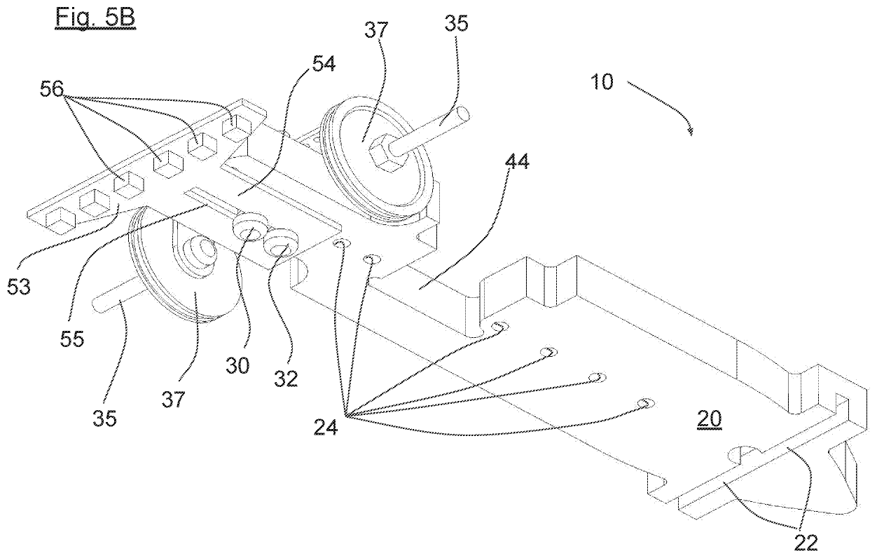

FIG. 5A shows the car kit 10 having a line following circuit board 54 installed in front of the front axle 34 (in this view). The line following board 54 has the general shape of a “T” in the illustrated embodiment, where the narrow portion is mounted between the wheels 37, and the wider portion is in front of the wheels 37 (in this view). On the bottom side of a bracket 53 (an extension of the line following circuit board 54), are a plurality of photosensors 56. These light-detecting sensors 56 may consist of reflectance, or color-detecting, photosensors; an exemplary electronic device that could be used for this purpose is a part no. QRE1113GR reflective object sensor, sold by Fairchild Semiconductor. The narrow portion of the line following circuit board 54 has a mounting slot 55, which can be fastened with the same screws 30, 32 used to mount the circuit board 26, and the front axle 34. The kit builder can adjust how far in front of the car 10 the line following board 54 will extend (in this view), based on where the screws 30, 32 are fastened through the mounting slot 55.

FIG. 5B illustrates the underside of the car kit 10, with the line following circuit board 54 installed in front of the front axle 34. The sensors 56 are shown protruding in a downward direction from the line following board 54. Note that the rear groove 22 extends all the way through the floorboard 20, from side to side.

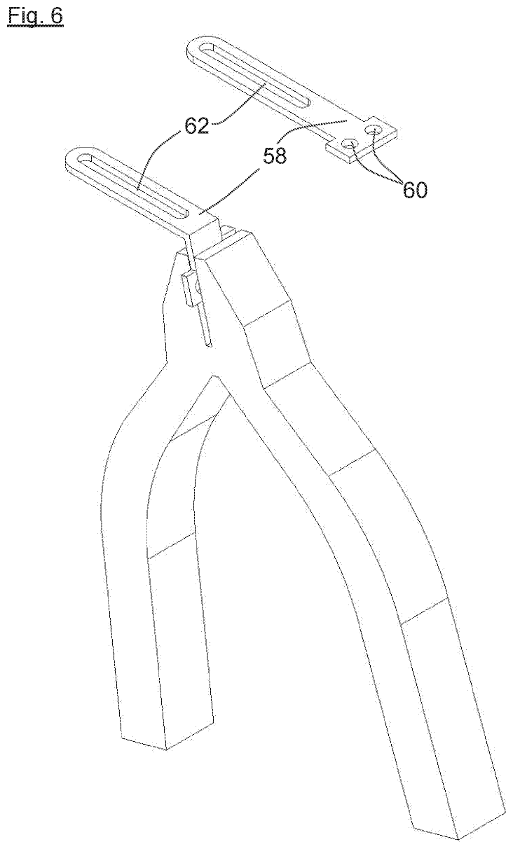

Referring now to FIG. 6, a camera mount 58 is shown in two configurations. The first configuration of the camera mount 58 is flat, and the second configuration is bent. Similar to the front axle 34, the camera mount 58 can be provided as a flat piece, so that the kit builder can bend the camera mount 58 in various angles. Determining the “best” camera mounting angle is another construction challenge provided to the kit builder by providing the camera mount 58 as a flat piece. The camera mount 58 includes mounting holes 60 that are used for mounting a camera, and a mounting slot 62 used for mounting to the floorboard 20.

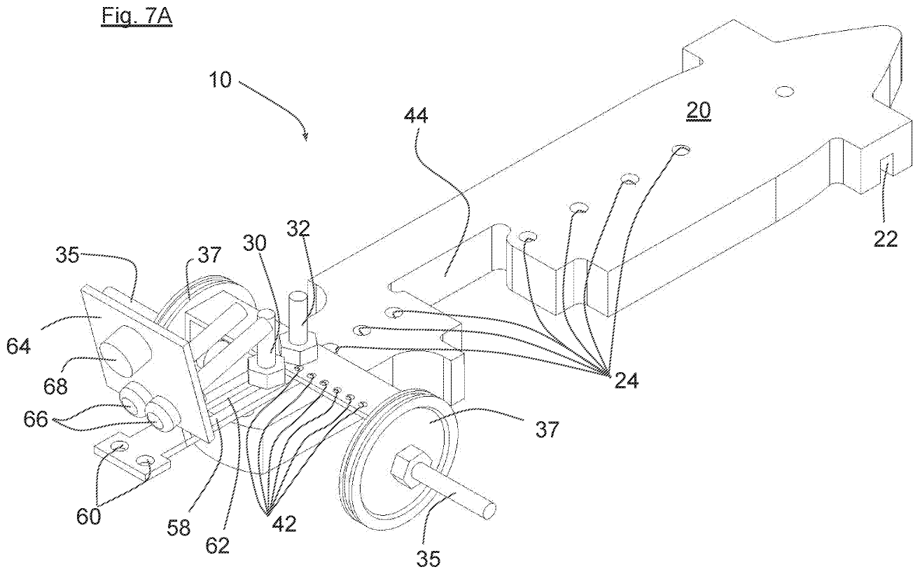

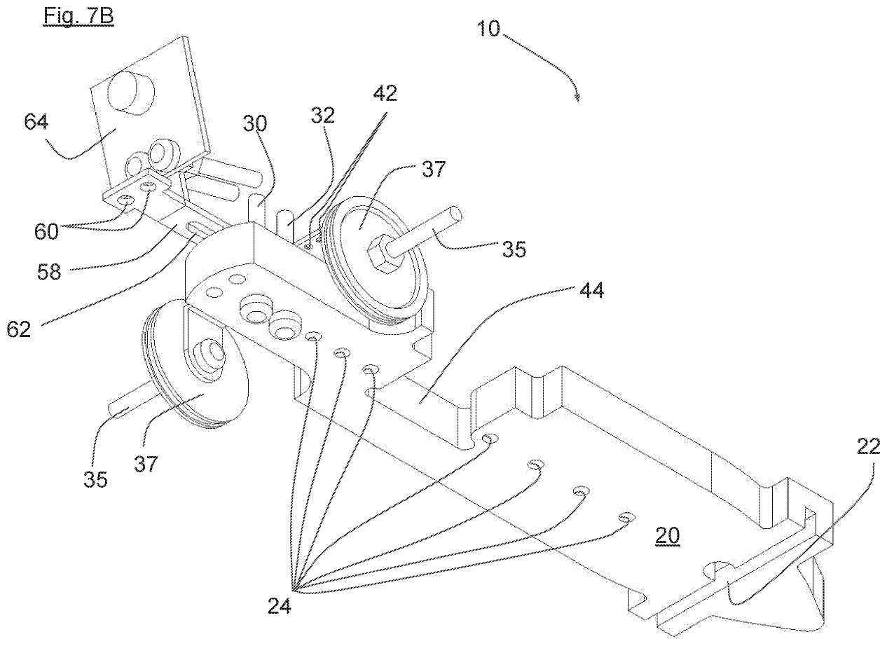

FIG. 7A shows the camera mount 58 installed on the floorboard 20 of the car kit 10 near the front wheels. The camera mount 58 is installed beneath the front axle 34, by fasteners 30, 32. A computer vision camera subassembly 64 is mounted to the camera mount 58, in a manner that the camera sensing element 68 is angled somewhat downward at the front of the car 10 (in this view).

FIG. 7B illustrates an underside view of the car kit 10, similar to that of FIG. 7A, with the camera mount 58 installed at the front of the car 10 (in this view).

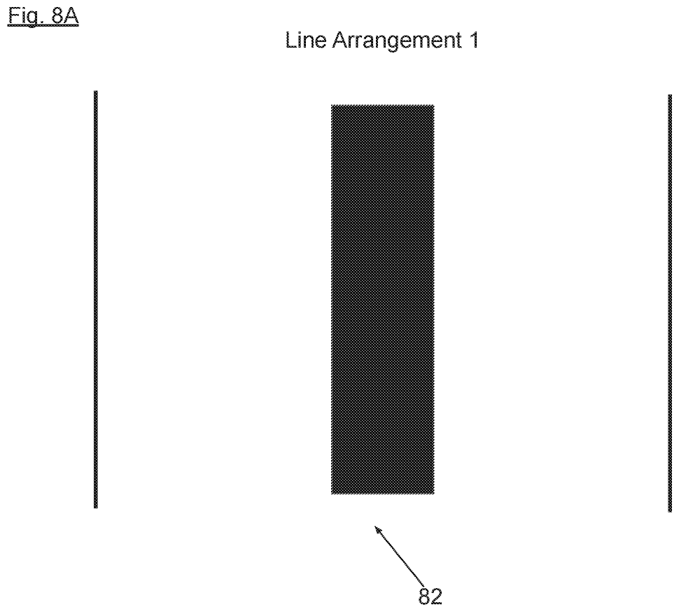

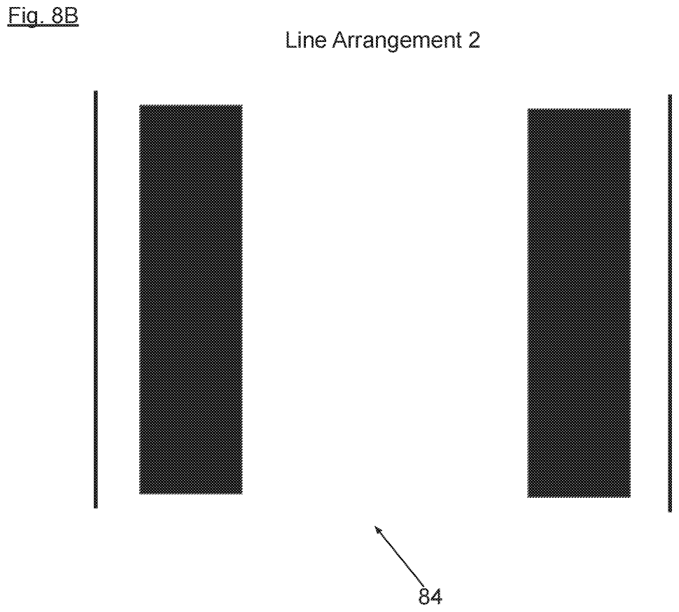

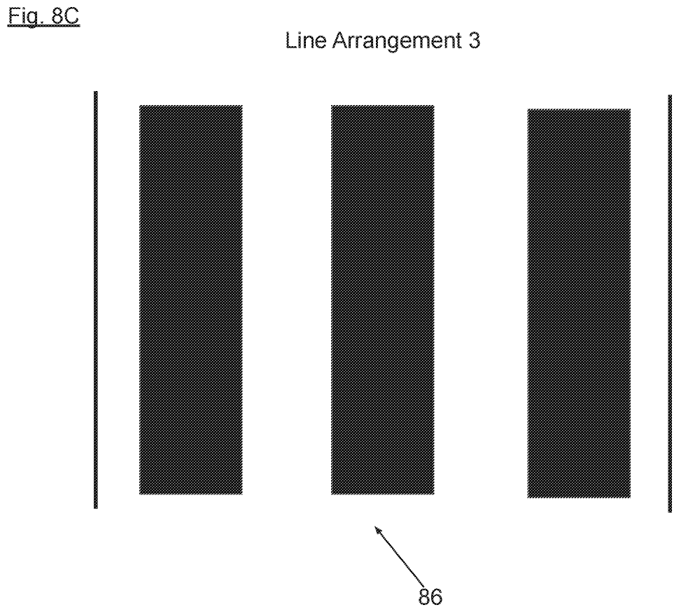

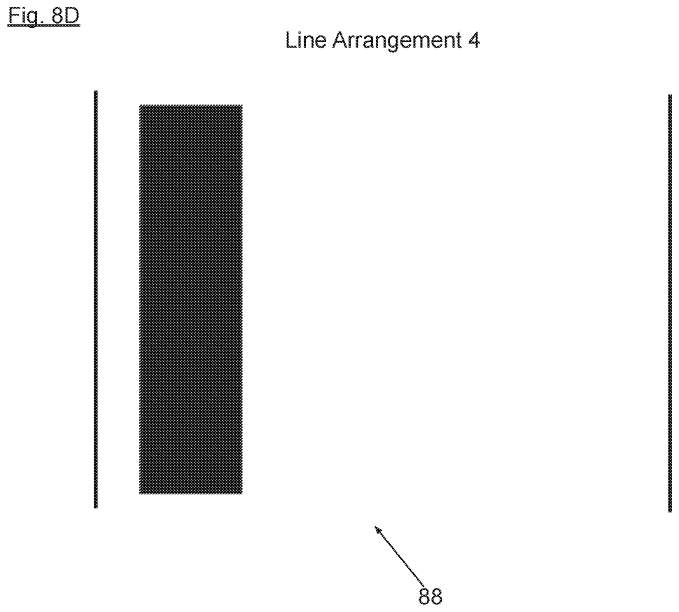

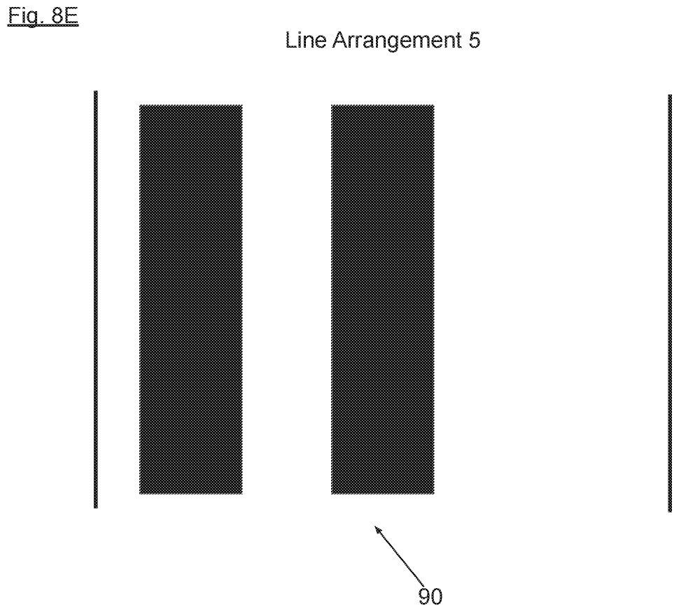

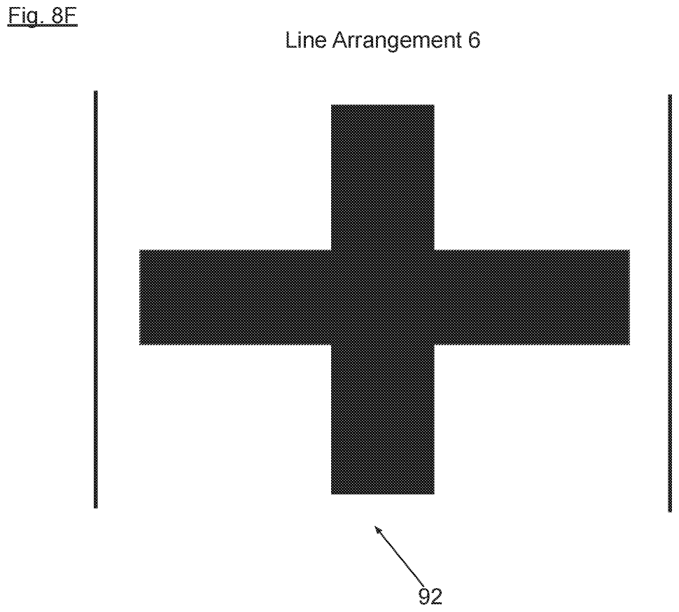

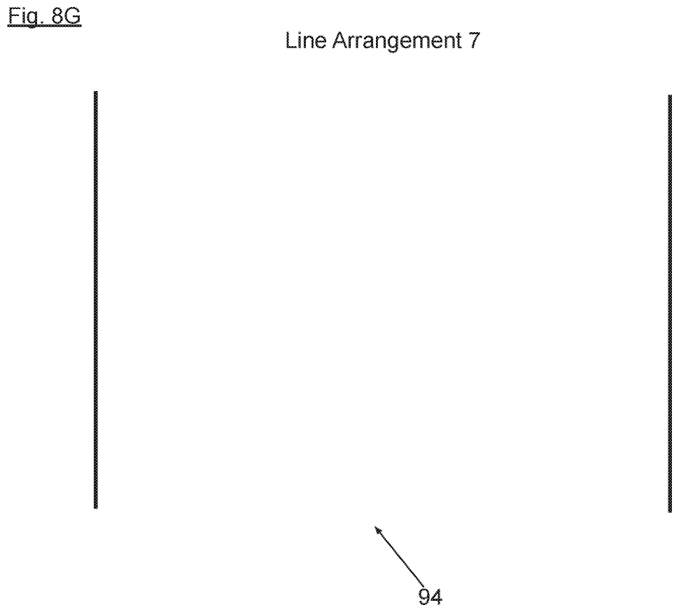

FIGS. 8A-8G show various indicia patterns that may be applied to a roadway 96 of a race course 80. These patterns or stripes are detected by the line following circuit board sensors 56 and/or the computer vision camera S/A 64 on the car 10. The sensors 56 and/or camera 68 transmit signals representing the detected patterns to the circuit board 26 and are translated by a processor. The processor then sends a signal to the servo 46, and the servo will rotate the spline 48 which moves the arm 50. One the arm 50 moves, the servo link 52 will move left or right, which correspondingly steers the front axle 34 left or right, because the link 52 is attached to the servo holes 42 on the front axle 34.

In greater detail: FIG. 8A illustrates a first pattern, or line arrangement having a single stripe in the direction of travel of the car 10. FIG. 8B illustrates a second pattern, or line arrangement having two stripes parallel to the direction of travel of the car 10, equally distant from the centerline. FIG. 8C illustrates a third pattern, or line arrangement having three stripes parallel to the direction of travel of the car 10, one in the centerline, and the other two on either side of and equally distant from the centerline. FIG. 8D illustrates a fourth pattern, or line arrangement having a single stripe in the direction of travel of the car 10 that is offset from the centerline. FIG. 8E illustrates a fifth pattern, or line arrangement having two stripes parallel to the direction of travel of the car 10, with one stripe in the centerline, and the other offset front the center in either direction. FIG. 8F illustrates a sixth pattern, or line arrangement having one stripe parallel to the direction of travel of the car 10, intersected by a stripe transverse to the direction of travel of the car 10. FIG. 8G illustrates no stripes, which can be defined as a seventh pattern, or line arrangement.

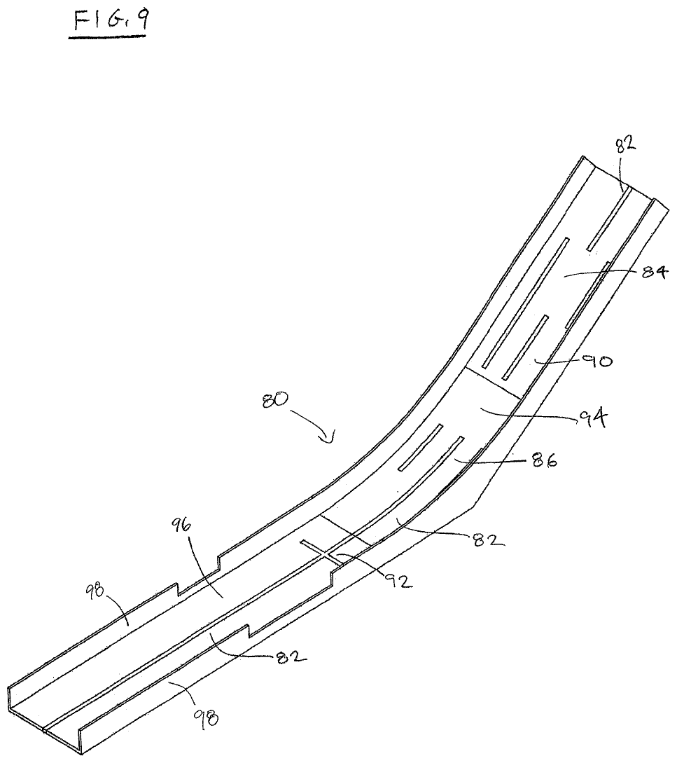

Referring now to FIG. 9, an example portion of a race course 80 is shown. The race course 80 includes a roadway 96 and at least one vertical barrier 98. Some of the various stripe arrangements shown in FIGS. 8A-8G are depicted on the roadway 96. Barrier height or presence may not be a consistent, adding an additional computational challenge.

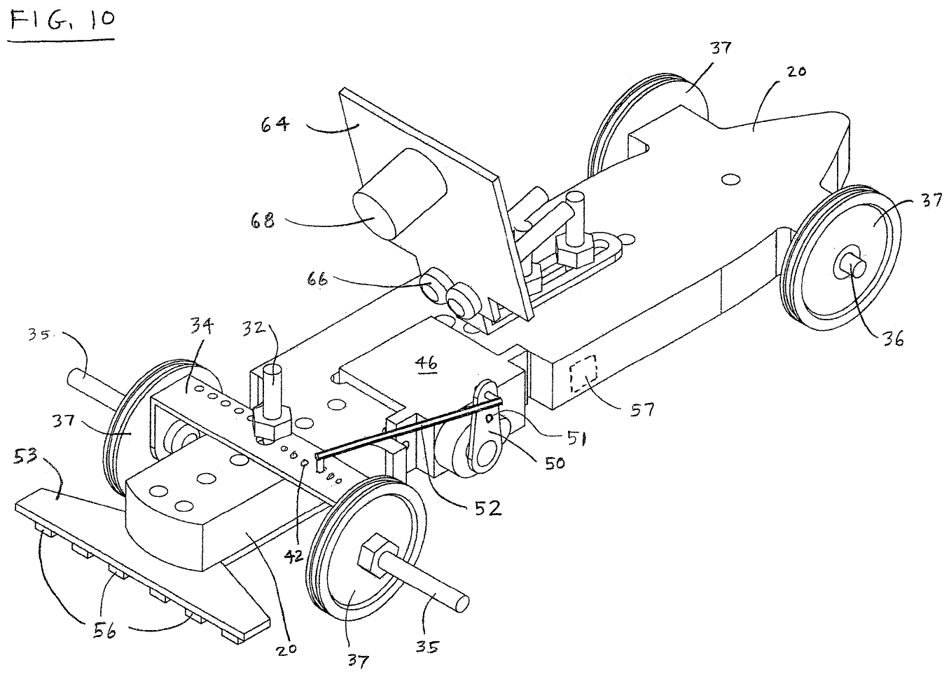

Referring now to FIG. 10, the car kit 10 is illustrated with the line following circuit board 54 mounted to the front of the chassis 20, and the computer vision camera mounted behind the servo 46 on the chassis 20. FIG. 10 is one example of how the car kit 10 can be customized during the build process. For example, the computer vision camera could be mounted directly over the servo 46. Note that the line following circuit board 54 is mounted in a different configuration here than in FIG. 5A. In FIG. 5A, the line following circuit board 54 is shown mounted far in front of the chassis 20, whereas in FIG. 10, the line following circuit board 54 is shown mounted almost directly beneath the front of the chassis 20. This is another example of how the car kit 10 can be customized.

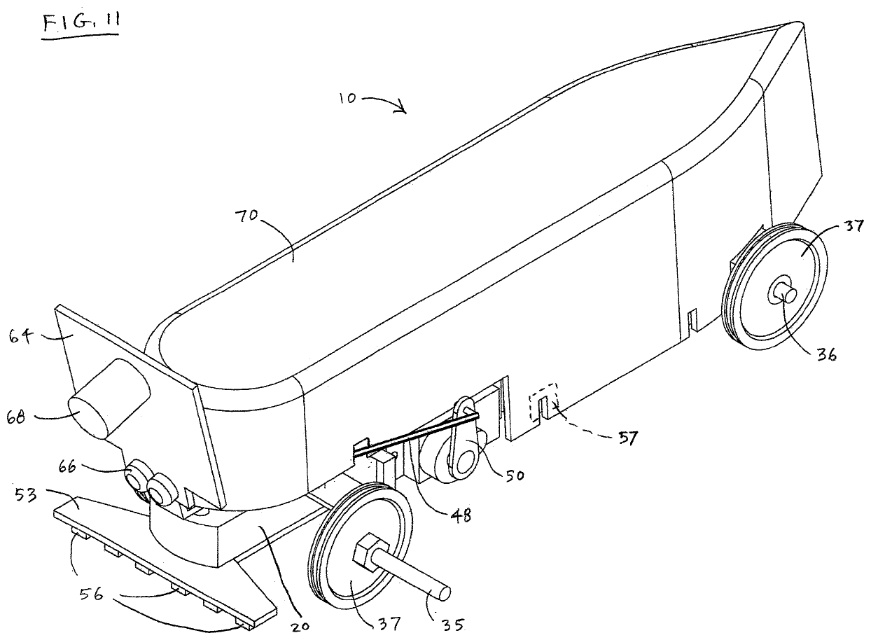

Referring now to FIG. 11, the car kit 10 is illustrated fully assembled. The upper body 70 is shown mounted on top of the chassis 20. The rear wheels 37 of the car 10 are fixed and may be jointly mounted to a single axle 36 or to individual axles. The wheels 37 may spin freely on the axle or be fixed to an axle that spins freely in the car body. The rear wheels 37 are not steerable and do not translate up or down, as with a spring suspension. The rear wheels 37 may be powered by a motor, spring, rubber band or other method, or may be unpowered.

The above disclosure information describes an unpowered (gravity powered) downhill autonomous car kit 10. The kit or car 10 is intended to be assembled by an end user (the kit builder), and ample opportunities for customization and differentiation are designed into the kit 10. The assembled kit 10 is intended to compete on a downhill race course 80 with a surface primarily in one color, with a contrasting color for stripes or multiple lines. The race lane 96 for a car 10 may be bound, or otherwise denoted, by a vertical or near vertical barrier 98 which may be of constant or varying height. The race course 80 slopes generally downward, but may include upward slopes and/or curves.

A more detailed description of some of the race car features follows, below:

Car Floorboard:

The car floorboard or chassis 20 includes a groove 22 in a fixed location, for the rear axle 36. Along the length of the floorboard 20 are evenly spaced holes 24, which act as mounting provisions. Hole spacing 24 matches the spacing of holes 28 on the car control circuit board 26, so that the circuit board 26 may be mounted in multiple locations at the user's discretion (see FIG. 1 and FIG. 2). Control circuit board 26 orientation (forward or backward) is at the discretion of the user. The front axle 34 of the car 10 is mounted to a vertical screw 32 in the floorboard 20. The location of this screw 32 is at the discretion of the user. The car 10 has a longitudinal axis between the front end (or a first end) and the rear end (or a second end). The shape of the floorboard 20 ensures that several options are available such that the overall car 10 wheelbase is adjustable.

Front Axle:

In the illustrated embodiment, the car kit includes a pre-drilled flat metal part 34, which the user should bend 90 degrees near the ends at their desired location (see FIG. 3). Pre-drilled holes include a center hole 38 for the vertical screw 32 mount, end holes 40 for a screw 35 which will hold the wheel 37, and multiple holes 42 to accommodate servo links. By providing the front axle 34 as a flat part, the user is able to adjust geometry such as ride height, toe in/out, and wheel spacing. It should be noted that the car kit, alternatively, could be provided with a pre-bent part 34, if desired.

Servo Mount:

The car floorboard 20 includes a cutout 44 for a horizontally mounted hobby servo 46 (FIG. 4). The servo 46 is mounted in a low profile orientation with respect to the frontal cross-sectional area of the car 10. The servo 46 is mounted at a similar elevation as the floorboard 20. The servo spline or output shaft 48 protrudes from the OML (outer mold line) of the floorboard 20 in a transverse direction with respect to the chassis' longitudinal axis, and a servo arm 50 is attached to the servo spline 48, pointing approximately vertically up or down in the neutral position. A servo link 52 attaches the servo arm 50 to the front axle 34. The servo link 52 attachment is accomplished through bends in the servo link 52, cylindrical link mounts, ball links, or a combination thereof. The steering system mechanical gain has a different value for each one of the front axle servo holes 42, and thus changes depending on where the builder mounts the servo link 52.

Controller Mount:

The controller circuit board holes 28 align with the spaced-apart holes 24 on the floorboard 20 using vertical fasteners 30 (FIG. 1 and FIG. 2). The controller circuit board 26 may be mounted directly to the floorboard 20 or may be mounted using an arrangement of spacers 31. In order to reduce circuit board 26 size, the circuit board 26 is mounted using a plastic spacer 31 between the circuit board 26 and the mounting nut or sleeve. An additional spacer 31 may be added below the circuit board 26 to add clearance from other components, such as the servo 46.

Line Following Circuit Board:

A first roadway detection sensor subassembly includes a circuit board 26 including one or more reflectance or color-detecting photosensors 56 may be mounted to the front of the car 10, roughly between the front wheels 37 and extending beyond the front wheels 37 (FIG. 5). The circuit board 26 has a roughly T shape, being narrow between the wheels 37 and wider forward of the wheels 37. The narrow portion of the line following board 54 includes a slot 55 in the center. This slot is designed to mount the line following board 54 to the bottom of the floorboard 20, and will line up with the evenly spaced holes 24 in the floorboard 20. This arrangement allows the line following board 54 to share fasteners 30, 32 with the front axle 34, control circuit board 26, or other components if desired by the user. The slot is long enough to accommodate two or more fasteners 30. The line following board 54 will include one or more reflectance or color-detecting photosensors 56 that face the race course 80 to detect lines (i.e., they act as ‘line following sensors’).

Camera Mount:

A second roadway detection sensor subassembly for the kit 10 may include a computer vision camera S/A 64, mounted with fasteners 66. In the illustrated embodiment, a flat pre-drilled metal camera mount 58 is included in the kit 10 for this purpose (see FIG. 6). At one end of the flat pre-drilled camera mount 58 are holes 60 that match mounting holes on the computer vision camera S/A 64. At the opposite end of the metal camera mount 58 is a slot 62, long enough to accommodate at least one of the evenly spaced holes 24 on the floorboard 20 (see FIG. 7). In this way the camera mount 58 can be mounted to the top or bottom of the floorboard 20, and can share fasteners 30, 32 with the front axle 34, control circuit board 26, line following circuit board 54, and/or other parts. By providing the metal camera mount 58 flat, the user is able to bend the camera mount 58 to set desired mount height and angle. It will be understood that the camera mount could be hinged to vary the cameral mount angle, if desired, or some other variable-angle structure could be used.

Wall Sensing:

A third roadway detection sensor subassembly for the kit 10 may include one or more distance sensors 57 that can be mounted to the car 10 as desired. These distance sensors 57 are designed to detect the barriers 98 that may be present on the track 80 to indicate the car's designated lane 96. In the illustrated embodiment, the distance sensors 57 are mounted on the side pods of the chassis 20.

Communication Between Components:

The car control circuit board 26 communicates with the line following circuit board 54, the computer vision camera 68, the distance sensor(s) 57, and the servo 46. Communication protocols such as I2C, Serial, SPI, pulse width, or other protocol, allow the control circuit board 26 to gather information from each sensor. The control circuit board 26 is programmable by the user. This allows the user to determine how to design the control system of the car 10 to successfully run down the race course 80.

A more detailed description of some of the race track (or ‘race course’) design features follows, below:

Race Course Design:

As robot programming competitions become more commonplace, a need exists for a race course 80 that is easy to produce, computationally challenging, and easy to change to new configurations. To this end, a race course or raceway 80 has been developed with a race surface or race lane 96 with up to three lines or stripes appearing on it in a variety of configurations, and with side walls 98 that retain the car 10 and provide a substantially vertical surface for distance measurement when present, or a computational challenge when absent.

In the case of a downhill (gravity) autonomous car (or autonomous guidance vehicle) 10, the car best able to identify and track the center and direction of the race surface 96 will reach the finish line in the shortest time. It should be noted that the race course described herein is equally applicable to horizontal race courses, or for use with powered vehicles. Identifying contrasting colored lines or stripes on the race surface 96 and walls 98 on the race lane boundaries is required to determine the race surface 96 center and direction. A variety of combinations of up to three parallel lines in the race surface direction, intermittent perpendicular lines to the race surface direction, and walls 98 that are alternately present or absent, or any combination thereof, present a computational challenge that is easy to assemble and easy to change.

By including more than one directional line on the race surface 96 the user must program his or her car 10 to determine the race surface center based on the positions and directions of the lines. By including multiple combinations of parallel lines, the user must program their car 10 with robust algorithms capable of processing multiple situations. By including lines perpendicular to the race surface 96, the user must further determine the direction of the race surface 96 by programming their car 10 with an algorithm capable of processing contradictory information.

Including walls 98 on the race course 80 gives the user an additional reference point for cars 10 using distance sensors 57. Using the car's distance from the wall 98 can help the user program their car 10 to determine where the center of the race surface 96 is. By alternately including and omitting walls 98 at various points on the race course 80 the user must program their car 10 with algorithms capable of processing information that may be inconsistently available.

Race Course Features:

The race course 80 consists of a flat or contoured surface with a finish line vertically below the starting line. The raceway 80 exhibits a distance of a predetermined length between the start line and the finish line, which determines the raceway course (or ‘race track’) 80. The slope of the race course 80 is generally down but may include upward slopes along the length. The race course 80 may be straight or curved. Each lane 96 of the race course 80 has a barrier 98 on each side of a height sufficient for the car sensors to detect the barrier 98, roughly the height of the car 10 or higher. The base color of the race course 80 is of a light or dark color, with contrasting dark- or light-colored lines, respectively.

The race course 80 includes combinations of lines both parallel to the intended direction of travel and perpendicular to the intended direction of travel, which are designed to present a computer vision programming challenge to the user (see FIG. 9). Different segments or roadway portions of the race course 80 can have different patterns of lines or stripes, and the car's guidance system will find it computationally difficult to interpret line or stripe patterns. These roadway portions are mounted next to one another to form a continuous racing surface, including a start line portion and a finish line portion, in the direction of racing.

Each roadway portion includes interconnecting physical features that allow a first roadway portion to be attached to a second roadway portion by the use of manual labor. This interconnectivity allows the raceway 80 to be extended to a desired length and in at least one desired direction.

The roadway sections may be physically separable sections or may be a single inseparable assembly. In the case of an inseparable assembly, the transition from straight to curved, or between different grade angles, may be accomplished by gluing or screwing the roadway surface to a shaped base of wood or other material, thereby causing the roadway surface to match the shape of the base. The divisions between sections of different computationally challenging line patterns may match physical separations, or may only denote sections of paint, tape or other colored marking means. In the case of a separable assembly, the roadway portion interconnecting physical features include a variety of designs. For example, one design includes a first mechanical extension on a first roadway portion, and a second mechanical extension on a second roadway portion, in which the first and second mechanical extensions are located at predetermined positions along edge surfaces of the first and second roadway portions and mate together to form at least a temporary mechanical connection. Another example design includes a first magnet of a first polarity on a first roadway portion, and a second magnet of a second, opposite polarity on a second roadway portion, in which the first and second magnets are located at predetermined positions along edge surfaces of the first and second roadway portions and mate together to form at least a temporary mechanical connection. A third example design includes a hook and loop fastener system, in which a hook material is affixed to a first roadway portion, and a loop material is affixed to a second roadway portion, at predetermined positions along the surfaces of the first and second roadway portions and mate together to form at least a temporary mechanical connection. A fourth example includes a tongue and groove arrangement, cut perpendicular to the race direction such that the resulting tongue and groove are parallel to the race direction, between the first and second sections such that a smooth transition is created, and the two sections are held together by the non-horizontal nature of the roadway surface. It will be understood that these examples are not exhaustive, and other types of interconnectivity could be used. In this description, the term “interconnectivity” includes all such disclosed connectivity features, or similar other interconnections, not explicitly disclosed herein.

While a race course 80 could be designed with one or two continuous lines that are substantially parallel to the edges, that type of race course 80 would be relatively easy to view and interpret, with regard to guiding the car 10 and keeping it on the race course 80 without bumping into one of the barriers 98 along the edge of the lane 96. However, a major part of this racing system is to make it a challenge to successfully steer the cars so that they do not bump against the outer edge barriers 98.

Examples of the various race course 80 patterns are described hereinbelow, in which there are a maximum of three parallel (to the direction of travel) stripes or lines on a given portion of the race course 80. In addition, as will be described and illustrated herein, there are also patterns of stripes or lines that can be transverse to the direction of travel, which will present a higher level of difficulty for the car's guidance system. It will be understood that other types of markings could be used on the race course roadway surface, such as combinations of more than three lines, patterns of spaced-apart circles, squares, or triangles, if desired, to increase the computational difficulty level. In this description, the terms “line” or “stripe” include all such disclosed pattern of roadway markings, or similar other patterns, not explicitly disclosed herein.

An exemplary first line arrangement 82 is a single line in the center of the lane 96 parallel to the intended direction of travel as illustrated in FIG. 8A. An exemplary second line arrangement 84 is two lines parallel to the intended direction of travel and equally distant from the lane 96 centerline (e.g., see FIG. 8B). An exemplary third line arrangement 86 is three lines parallel to the intended direction of travel, with one in the center of the lane 96 and two on either side of and equally distant from the center of the lane 96 (e.g., see FIG. 8C). An exemplary fourth line arrangement 88 is a single line parallel to the intended direction of travel that is offset from the center of the lane 96 (e.g., see FIG. 8D). An exemplary fifth line arrangement 90 is two lines, which are parallel to the intended direction of travel with one line in the center of the lane 96, and one line offset from the center in either direction (e.g., see FIG. 8E). An exemplary sixth line arrangement 92 is one or more lines parallel to the intended direction of travel intersected by a line perpendicular to the intended direction of travel (e.g., see FIG. 8F). An exemplary seventh line arrangement 94 does not have any lines (e.g., see FIG. 8G).

In order to present a programming challenge to the user, the six (6) arrangements outlined above can be combined in road way sections of any order to create an environment that is challenging to navigate using computer vision, or other types of electronic sensors.

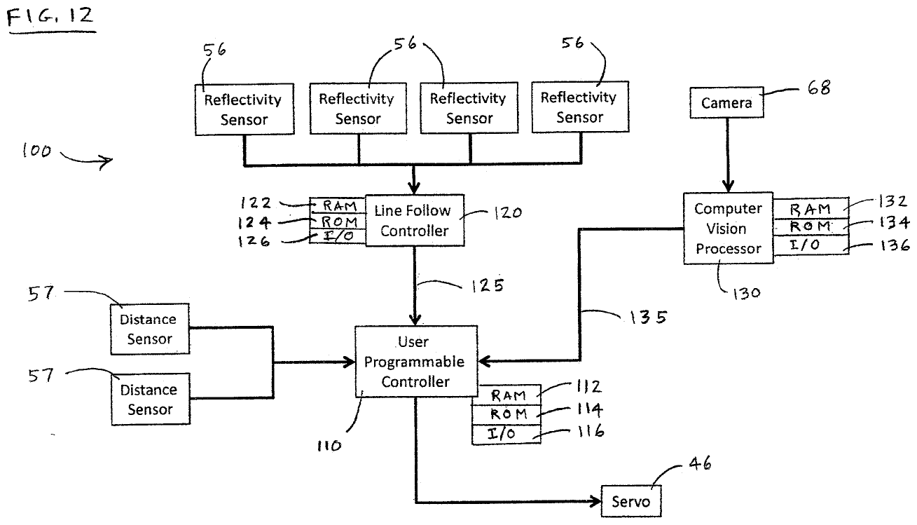

The electronic circuitry of the car kit is illustrated in block diagram form in FIG. 12. In this illustrated embodiment, electronic circuit includes at least one microprocessor (CPU) 110, Read Only Memory (such as a FLASH memory, and/or EEPROM {electrically erasable programmable read only memory}) 114, random access memory (RAM) 112, a battery (or other electrical power supply), not shown, and certain signal pathways for the sensors and the servo 46.

In the illustrated embodiment, there are three different ‘controllers’ depicted on FIG. 12: they are referred to as the ‘User Programmable Controller’ 110 (an exemplary electronic device that could be used for this purpose is the Atmel AVR ATMEGA32-U4), the ‘Line Following Controller’ 120 (an exemplary electronic device that could be used for this purpose is the Atmel AVR ATMEGA48PB), and the ‘Computer Vision Processor’ 130 (an exemplary electronic device that could be used for this purpose is the NXP LPC4330). Each of these controllers can physically exist as a separate microprocessor or microcontroller chip, which is how they are presented on FIG. 12. As electronic processors become yet more powerful, it will be possible to combine all functions for the car kit into a single processing circuit or otherwise distribute computational tasks across processing units, if desired by a system designer. However, ready-made video processor chips are presently available, and therefore, the ‘Computer Vision Processor’ 130 is a desirable product for controlling functions and receiving data—i.e., for interfacing with the vision system digital camera sensing element 68 (an exemplary electronic device that could be used for this purpose is the CMUcam5).

An input/output (I/O) interface circuit 116 is included to provide signal conditioning as needed between the CPU 110 and other components that typically use voltage and/or current levels that are not typically able to hook up directly to a processing device, such as sensors and output device driver circuits. Each appropriate I/O signal is directed through a separate channel of the I/O interface circuit 116, unless perhaps more than one signal of a particular voltage and current rating can be multiplexed, in which case a multiplexer circuit can be included in the I/O interface circuit 116. The data signals between I/O circuit 116 and the CPU 110 run through a low voltage signal bus which could be on-board the processor chip.

A human user (e.g., the kit builder) will have the ability to communicate with the processing circuit 110, so as to upload certain types of predetermined information into its memory circuits 112 or 114. Therefore, the input/output interface circuit 116 will include a communications interface circuit so as to enable such uploading function. Such user-defined predetermined information will have various forms, depending upon the ‘difficulty level’ of programming challenge, which is discussed below in more detail.

The other two controllers 120 and 130 include similar memory and I/O circuitry. The ‘Line Follow Controller’ 120 would typically include its own processing circuit, Read Only Memory (such as a FLASH memory, and/or EEPROM {electrically erasable programmable read only memory}) 124, random access memory (RAM) 122, and certain signal pathways for the (reflectance or color-detecting) photosensors 56. An I/O interface circuit 126 is included.

The ‘Computer Vision Controller’ 130 would also typically include its own processing circuit, Read Only Memory (such as a FLASH memory, and/or EEPROM {electrically erasable programmable read only memory}) 134, random access memory (RAM) 132, and certain signal pathways for the camera sensing element 68. An I/O interface circuit 136 is also included.

In addition, there are data and signal buses between the various processing circuits 110, 120, 130 that are part of this overall circuit design, including a data/signal bus 125 between the ‘User Programmable Controller’ 110 and the ‘Line Following Controller’ 120, and a data/signal bus 135 between the ‘User Programmable Controller’ 110 and the ‘Computer Vision Processor’ 130. In such complex processing systems, with more than one controller, it is typical for one of the processing circuits to be the overall controller, and in this circuit design, that overall controller is the ‘User Programmable Controller’ 110. To properly perform its functions, that controller 110 will need to receive appropriate data in real time from the other two controllers 120 and 130, and the data/signal buses 125, 135 allow that task to be performed.

Programming Level of Difficulty

The computer program used in the ‘main’ guidance controller, which, for this product, is the ‘User Programmable Controller’ 110, can be provided partially by the car kit seller, and partially by the user. For younger persons (those under ten years old, for example), the user's portion of the control software for controlling an output actuator (e.g., the servo 46) could be simplified to the extent that the user only needs to load a text message into predetermined registers of the memory circuit (into RAM 112, or EPROM 114), or into a graphical interface which automatically generates executable code for upload (into RAM 112, or EPROM 114), and the remainder of that ‘main’ guidance control software could be already resident in that same memory circuit. The user-provided text message would represent certain attributes that would then be used by the car kit seller's portion of the ‘main’ guidance control software, and that user-provided information will have a physical effect on how the car kit steering will function.

For slightly older persons (those over twelve years old, for example), the user's portion of the control software for controlling the servo 46 (an output actuator) could be required to create a control algorithm based on a limited set of variables and programming commands. At this intermediate difficulty level, the ‘knowns’ for the user could be the memory locations of the input sensors and the output actuator(s), such as the camera, and the servo 46. The available information from the sensors would be limited and pre-determined to allow the user to focus on a single aspect of programming, while providing a challenging competition for more than one age group.

For older persons (those over fourteen years old, for example), the user's portion of the control software for controlling the servo 46 (an output actuator) could be required to do virtually everything. At this higher difficulty lever, the only ‘knowns’ for the user could be the memory locations of the input sensors and the output actuator(s), such as the photosensors or distance sensors, and the servo 46. This would be one form of programming difficulty that would make using these car kits more enjoyable (and fairer to use in competitions) for more than one age group.

The race car kit 10 may be provided with variable levels of difficulty, in which the goal of the programming is to prevent collisions with roadway walls or barriers 98 and to traverse the roadway 96 in the shortest time. The control software runs on the main controller 110, and can be provided with more than one different program or be programmed by more than one different programming tool.

A first difficulty level provides an easy to program race car kit 10 in which all control outputs are determined by pre-set programming in which the user (the kit builder) fills in blank values, which interpret the output of at least one sensor and provide an output signal to the servo 46. A second difficulty level may utilize a similar programming environment or main controller software, but utilize the outputs from a different set of sensors. A third difficulty level requires true programming to receive at least one sensor input and provide at least one servo output for race car control, in which programming is performed using text or graphical programming tools and basic control algorithms are provided. In a fourth level of difficulty, the kit builder uses true programming utilizing the outputs of more than one sensor, and in which the kit builder creates their own control algorithms

User Interface Display Screen:

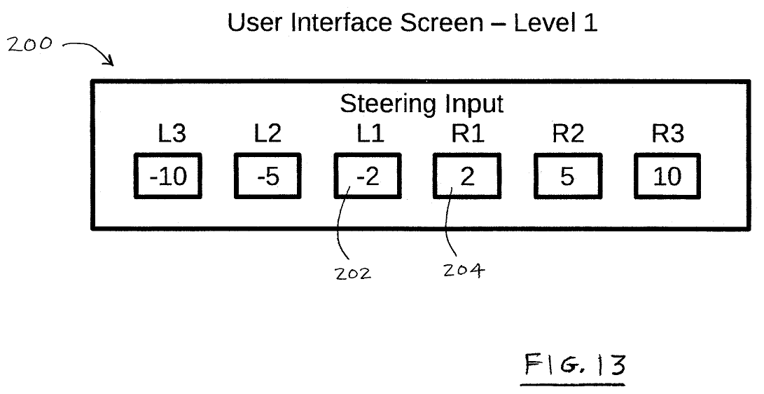

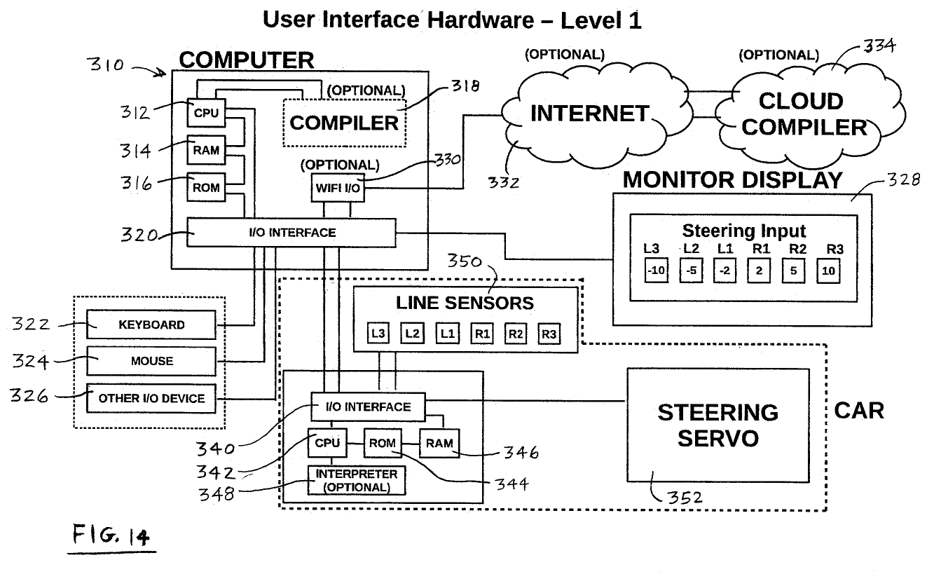

The user is provided with a visual interface (a display screen) that includes a number of numerical inputs corresponding to the number of line sensors on the race car line following board 53. FIG. 13 illustrates an exemplary screen 200 that shows six line detecting sensors for one of these race cars. The line following circuit board 53 may include a central line sensor that can directly detect a “Center” position and output a signal to indicate that status, or the “Center” position may be deduced by a line detection simultaneous result using the most central two line sensors 56 (e.g., the L1 and R1 sensors—see FIG. 13, at 202 and 204, and FIG. 14).

This arrangement is intended to give the user a direct relationship between race car hardware and user generated software. The values input by the user in each of the interface blocks (e.g., 202, 204) correspond directly to a steering value of the race car when a line on the roadway surface is detected by the corresponding line sensor(s) 56. It should be noted here that this description of ‘how’ the sensors and steering software operate is based on a race track in which every one of the roadway sections has only the central stripe as the indicia; in other words, each and every one of the roadway sections will have the appearance that is illustrated in FIG. 8A, also described as “Line Arrangement 1.” This assumption is used herein only for the purpose of simplifying this explanation of operation of this race car-software system. An actual race track can of course be made up of any combination of roadway sections, with differing indicia patterns.

User Interface Hardware Diagram, Level 1:

Referring now to FIG. 14, an exemplary hardware system diagram is illustrated, showing the major electronic components used for interfacing with and programming a Level 1 autonomous model race car. A user computer, generally depicted by the reference numeral 310, includes a processing circuit (the CPU at 312), and a memory circuit (the RAM 314 and ROM 316). An I/O (input/output) interface circuit 320 is used to communicate signals to and from external electronic components such as a keyboard 322, mouse 324, other I/O devices 326, a monitor display 328, and to an I/O interface 340 that is on-board the model race car. The user computer 310 may also include a wireless communications I/O circuit 330 that can communicate with the Internet 332 and/or the cloud 334, as an optional feature.

The model race car includes its own processing circuit (the CPU at 342) and its own memory circuit (the RAM 344 and ROM 346), which store certain important variables and which store an executable computer program that controls the steering of the race car. For this autonomous race car to properly operate, its CPU needs to receive real-time input signals from the line sensors (as a group, reference numeral 350), and its CPU needs to be in communication with a “steering driver” circuit 352, which controls a servo (such as the servo 46, seen on FIG. 4).

When programming a Level 1 race car, the user (on the monitor display 328) is provided with a visual display page 200 (e.g., see FIG. 13), including a number of input boxes (e.g., at 202) corresponding directly to the number of line sensors on the race car—for a Level 1 car, there are line sensors only. Through the use of the keyboard 322, mouse 324, or other input device 326, the user inputs a steering value that they wish the race car to execute when a roadway line is detected by the corresponding line sensor. These input variable values are either transmitted (using an “Upload” screen on the monitor 328) directly to the race car (via the I/O interface circuit 340), which loads them into the race car's non-volatile ROM, or the system first compiles the values into a computer program executable by the race car CPU 342. This compilation may occur on the user's computer or in the cloud.

The preferred operating system for the Level 1 race car can execute either a compiled computer program, or an interpretive computer program. More advanced users may prefer to use a compiler that is either in the cloud 334 or on-board the user computer 310 (as a software module 318). Either version of a compiler is optional.

The alternative to a compiled program is to create a computer program (on the user computer 310) that will run using an (optional) interpreter 348 that is on-board the model race car. The interpreter must be quick enough to execute the interpretive program, while keeping up with the signals arriving in real time from the line sensors 350, and thus be able to provide the necessary steering commands to the steering driver 352 (essentially in real time). Otherwise, of course, the race car will likely crash—the entire race track is not necessarily a straightaway.

Once values have been loaded into the race car, the race car CPU will determine the position of the center line on the race track by determining which one (or two) line sensor(s) is active—i.e., which one or two input sensor(s) is detecting the center line on the race trace. The steering value assigned to the active sensor will then be transmitted to the steering driver 352, and the race car will move (will be steered by the servo 46) as the user intended under the specific condition encountered.

Software Logic Diagram 1:

The race car electronic circuitry first reads the output signals produced by all of the available line sensors 350. Race car software (executing on the CPU 342) then determines which sensors are active and, utilizing an algorithm, determines which sensors are erroneously active, if any. (Note: sometimes a sensor may perceive an erroneous input value that should be treated as a ‘phantom’ input. See below for further discussion of dealing with that phenomena.)

In some cases, two (2) line sensors will detect the roadway surface line in the same sampling cycle. If, for example, a “center sensor” is emulated by both the R1 and L1 sensors (noting that neither of these sensors is positioned directly as the center of the sensor array), the algorithm will determine that the race car has detected a line in the center (i.e., between the two sensors R1 and L1). The steering input value determined earlier by the human user that corresponds to the resulting detected line position is then transmitted to the steering driver 352 (i.e., the steering actuator, e.g., a servo), and the race car executes the intended steering operation.

It should be noted that, if two of the line sensors simultaneously detect a roadway line indicia, then the executing software algorithm will typically be programmed to ‘average’ the line sensor variable input values. In other words, if the variable values for the steering inputs depicted on FIG. 13 are used, and if both L1 and R1 are simultaneously active, then the input variable values of “−2” and “+2” will be averaged, which of course (in this example) equals zero (0). If a value of zero for the steering driver results in a command of steering straight ahead, then that will be the physical result of that set of input values from the line sensors. As another example, if both line sensors R2 and R3 are active, then their input variable values of “+5” and “+10” will be averaged, which then would result in a command of +7.5, which then would be sent as the steering command to the servo's steering driver circuit 352.

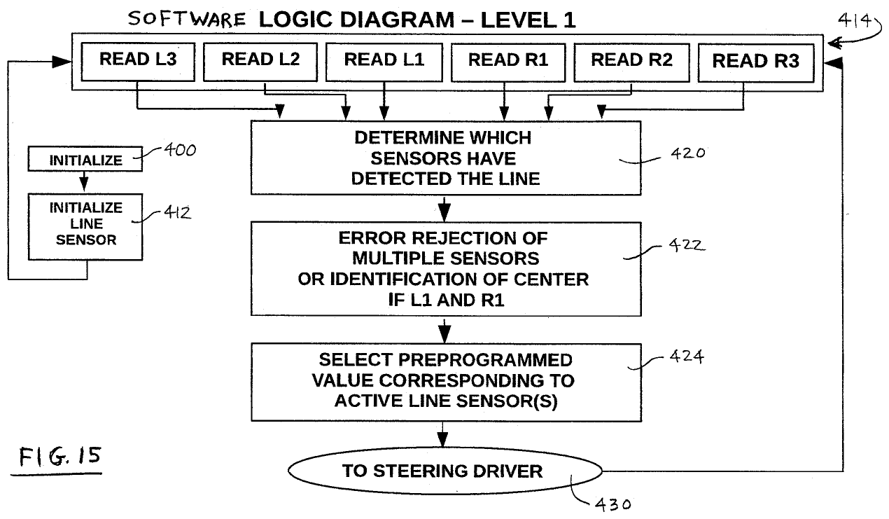

Referring now to FIG. 15, some of the important functions performed by the software logic used by a Level 1 race car is depicted as a flow chart. Starting at an initialization step 400 (executed when power is first turned on for the CPU 342), the processing circuit needs to determine which set of sensors is going to be in effect for this particular model vehicle. In this example, the “Level 1” sensors will be used, which is depicted as a status box 410 on FIG. 15. In a Level 1 race car, only the line sensors 56 are to be used, and they will be initialized at a function step 412, so they properly communicate with the CPU 342.

After step 412 occurs, the executing software will quickly read the logic states of the various line sensors, at a function step 414. In this example, there are six (6) line sensors, known as “L3”, “L2”, “L1”, “R1”, “R2”, and “R3”, as discussed above in reference to FIG. 13. A ‘read sensors’ function at a step 420 is to determine which, if any, of those six sensors are detecting a line or stripe (i.e., indicia) on the roadway surface that the race car is currently occupying, or about to enter as the car is moving.

An important (but optional) feature is to reject inappropriate input signal states, and to reject inappropriate output commands before such commands are sent to the steering driver circuit. A function step 422 is provided to detect potential multiple sensor ‘line detections’ that may lead to a ‘false’ identification of the center line stripe on the roadway surface. As noted above, if two adjacent sensors simultaneously detect the line stripe, then—usually—the ‘command values’ for those two sensors will be averaged, and that result will then be sent to the steering driver circuit.

But, for example, if two non-adjacent sensors simultaneously detect the line stripe, then some type of error has likely occurred—perhaps an optical reflection that ‘fakes out’ one of the line sensors. In that event, the function at step 422 will need to make a decision about what to do, with regard to the appropriate signal value to send to the steering driver circuit. Most likely, the most recent output value that was sent to the steering driver circuit would be maintained, until the next sampling cycle was taken of the line sensors, which will (hopefully) no longer see that false reading on one of the line sensors.

Another potential problem would be if the sampled readings of one (or more) line sensors would cause the output command to the steering driver circuit to suddenly shift from ‘hard left’ to ‘hard right,’ from one sampling cycle of the line drivers to the very next sampling cycle. The modern electronics available today are sufficiently fast enough to ‘see’ relatively slight changes in the position of the center line stripe on the roadway surface, as the race car moves down the race track. In other words, there should never be that drastic a sudden change in the detected line stripe position, with respect to the array of line sensors used in the Level 1 race car, as the input values are sampled over and over, in real time.

Once the input signals from the line sensors are ‘processed’ by the function steps 420 and 422, a step 424 now determines an appropriate output value that is to be sent to the steering driver circuit. That signal output value is then applied to the physical steering driver circuit 352 (i.e., that controls the steering servo 46) at a function step 430. The steerable wheels of the race car will then be steered accordingly.

It will be understood that the executing software for the race car will cycle back to the ‘read’ step 414, over and over, to constantly update the CPU 342 with the most recent input data, and then to update the output commands to the steering driver circuit 352. These functions must be performed, essentially continuously, until the race car has run over the entire race course, and will probably keep running through their logical operations until power is turned off to the electronics in the race car. In more advanced versions of this type of race car, a user may decide to include some diagnostic programs in the on-board software, but that is separate from the main logic diagram program discussed above.

User Interface Hardware Diagram, Level 2:

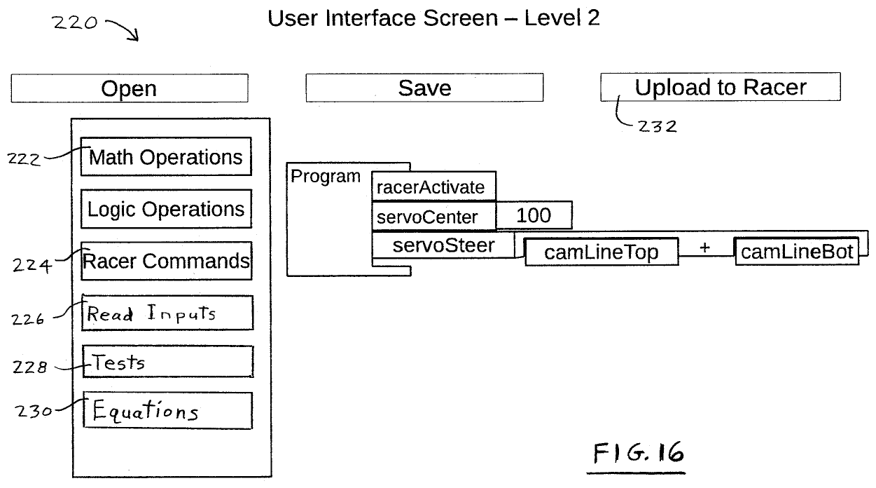

When programming a Level 2 race car, the user is provided with a number of graphical elements that can be ‘dragged’ about the display using a mouse or other input device. See FIG. 16 as an example of such a display screen, generally designated by the reference numeral 220. These graphical elements may be mathematical operations, such as addition and subtraction (at button 222), race car commands, such as steering values (at button 224), race car inputs, such as lines detected by the camera (at button 226), or may represent programming concepts, such as logical tests (at button 228), and variables and equations (at button 230).

The user creates a visual program using the available commands and/or equations with the intention of creating a steering position based on the detected line positions. The resulting program is then either (1) transmitted directly to the race car (which will then be interpreted by the race car's CPU 342), which loads the program instructions into the race car's non-volatile ROM 344; or (2) the resulting program is compiled into a computer program file that is directly executable by the race car's CPU 342. This compilation may occur on the user's computer or in the cloud. Note: one suitable interpreter language is known by the brand name “Circuit Python.”

Once the program has been loaded into the race car's memory circuit (using button 232), the race car's CPU 342 will determine the position of the line on the track based on the race car inputs the user has available for this level of race car, using his or her computer program. The resulting steering value will then be transmitted to the steering driver 352, and then to the steering actuator (e.g., a servo), and the race car will move as the user intended under the specific condition encountered.

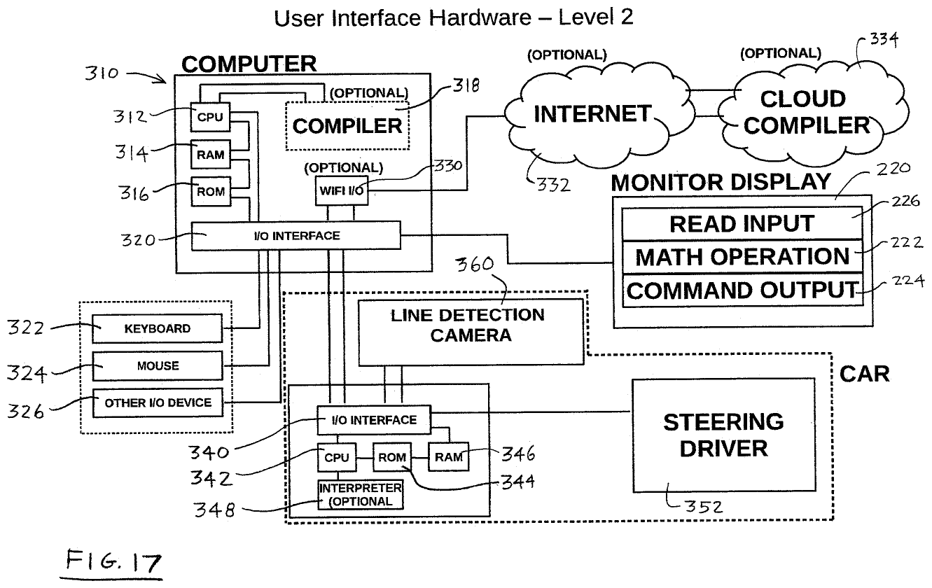

The Level 2 hardware is depicted in FIG. 17. It should be noted that the Level 2 hardware is almost exactly the same as the Level 1 hardware that is depicted in FIG. 14. The only significant hardware difference is that a ‘line detection camera’ 360 (i.e., a digital camera—referred to above as a ‘computer vision camera’ 64) is used in the Level 2 race car, whereas in the Level 1 race car an array of individual line sensors 350 was used. As described above, in reference to FIGS. 5A and 5B, the individual line sensors 56 are essentially ‘single-channel’ photosensors, and each one is a very different type of device than a digital camera, which typically outputs thousands of signal values per image, i.e., one signal value per each individual pixel (on an X-Y grid).

Accordingly, the software needed to control the race car based on image data from a digital camera (Level 2) will be quite different than the software needed to control the race car based upon multiple line sensors (Level 1). This, of course, is by design, and provides a much different challenge to users who may work with different levels of this type of autonomously-steered race car.

The other significant different between working with either Level 1 or Level 2 systems is the types of monitor display screens that can be made available for the user to create the necessary computer program. Examples of such display screens are provided at FIG. 13 (for Level 1) and FIG. 16 (for Level 2). The differences are apparent, and of course, other versions of programming screens can be used, without departing from the inventive principles disclosed herein.

Software Logic Diagram 2:

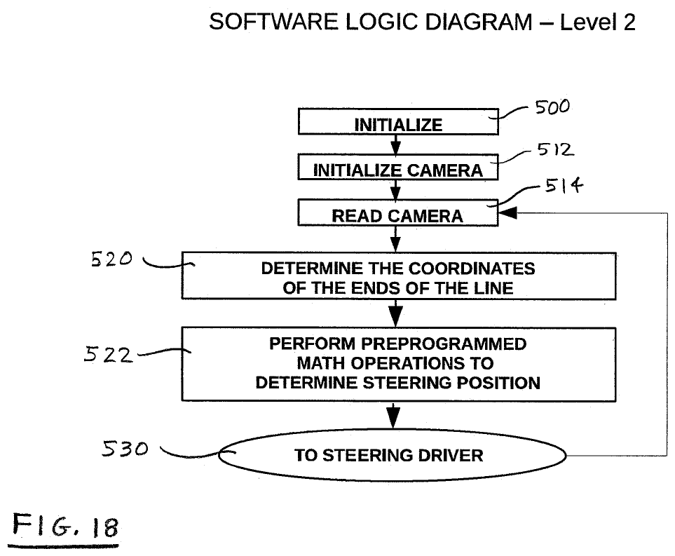

Referring now to FIG. 18, some of the important functions performed by the software logic used by a Level 2 race car are depicted as a flow chart. Starting at an initialization step 500, the processing circuit needs to determine which set of sensors is going to be in effect for this particular model vehicle. In this example, the “Level 2” sensor(s) will be used, which is depicted as a status box 510 on FIG. 18. In a Level 2 race car, only the digital camera (the ‘line detection camera’ 360) is to be used, and it will be initialized at a function step 512, so the camera properly communicates with the CPU 342.

After step 512 occurs, the executing software will quickly read the pixel values output by the digital camera, at a function step 514. The image values need to be deciphered to determine where, in the image data, a line (or stripe) exists on a roadway surface. A function step 520 is used to determine the coordinates of the ends of the line, if such line has been found in that image data. Step 520 is attempting to determine the coordinates of the roadway surface line (or stripe) that may exist anywhere in the camera's field of vision. The camera is typically looking ‘forward,’ and therefore, the camera's data is attempting to detect a line or stripe (indicia) on the roadway surface that the race car is currently occupying, or is about to enter as the car is moving.

An optional feature to reject inappropriate input signal states, and to reject inappropriate output commands before such commands are sent to the steering driver circuit, could still be used in the Level 2 race car. However, since the image data covers an entire (rectangular) area of space, the ‘coordinate determining function’ of step 520 more or less automatically takes care of ‘finding’ and then ‘rejecting’ false, or ‘phantom’ readings. For example, if the image data for a particular image scan cycle is somehow corrupted, then the ‘coordinate determining function’ of step 520 should simply ‘dump’ that entire image scan cycle and keep using the most recent, previous image data scan until the next non-corrupted scan cycle of image data becomes available. This would occur very quickly in real time, unless of course, some type of hardware failure should occur.

Once the pixel data signals from the camera are ‘processed’ by the function step 520, a step 522 now determines an appropriate output value that is to be sent as a signal to the steering driver circuit. This determination involves whatever math functions and computer logic instructions that have been programmed by the user into the race car's software that controls the operation of the on-board CPU 342. That output signal value is then sent to the physical steering driver circuit 352 (i.e., for controlling the steering servo 46) at a function step 530. The steerable wheels of the race car will then be steered accordingly.

In the general case, the race car software determines the coordinates of a roadway surface line (or stripe) in the computer vision camera's field of vision. These coordinates are then made available for access by the user-generated program. The user-generated algorithm then creates a steering value based on the inputs the user has selected, which may include the coordinates of the line detected by the camera. This steering value is then transmitted to the steering driver circuit 352.

It will be understood that the executing software for the race car will cycle back to the ‘interfacing’ step 512, over and over, to constantly update the CPU 342 with the most recently scanned input data, and then to update the output commands to the steering driver circuit 352. These functions must be performed, essentially continuously, until the race car has run over the entire race course, and will probably keep running through their logical operations until power is turned off to the electronics in the race car.

User Interface Hardware Diagram, Level 3:

When programming a Level 3 race car, the user is provided with graphical elements that can be ‘dragged’ about the display using a mouse or other input device, similar to programming the Level 2 race car—see FIG. 16. As before, these graphical elements may be mathematical operations, race car commands, race car inputs, or may represent programming concepts, such as logical tests, and variables and equations.

And, similar to a Level 2 race car, the user creates a visual program using the available commands and/or equations with the intention of creating a steering position based on the detected line positions. The resulting program is then either (1) transmitted directly to the race car (which will then be interpreted by the race car's CPU 342), which loads the program instructions into the race car's non-volatile ROM 344; or (2) the resulting program is compiled into a computer program file that is directly executable by the race car's CPU 342.

Once the program has been loaded into the race car's memory circuit, the race car's CPU 342 will determine the position of the line on the race track based on the race car inputs the user has available for this level of race car, using his or her computer program. The resulting steering value will then be transmitted to the steering driver circuit 352, and then to the steering actuator (e.g., a servo), and the race car will move as the user intended under the specific condition encountered.

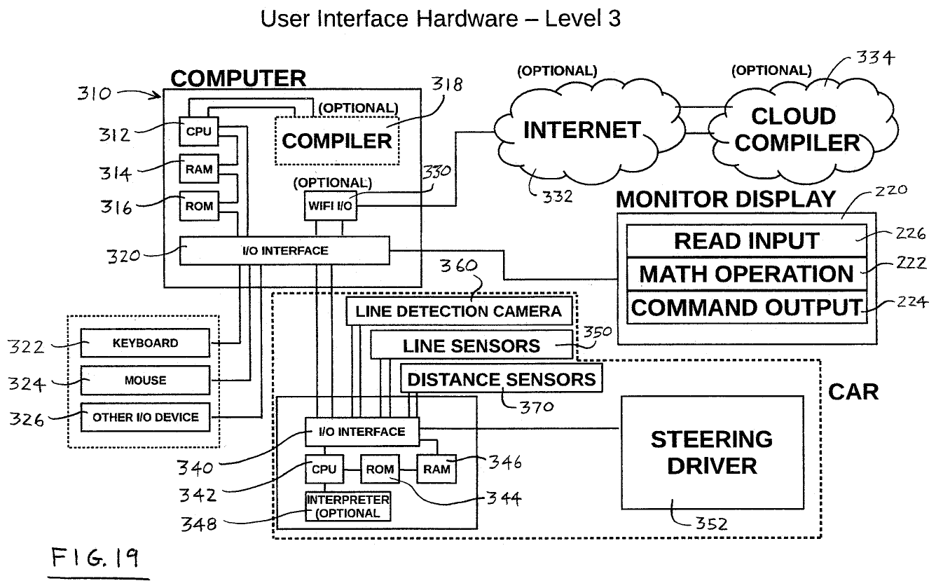

The Level 3 hardware is depicted in FIG. 19. It should be noted that the Level 3 hardware is mainly a combination of the Level 1 hardware (see FIG. 14) and the Level 2 hardware (see FIG. 17). In a Level 3 race car, the user has available both the array of individual line sensors 350 and the line detection camera 360. In addition, the user also has an optional set of ‘distance sensors’ 370—this embodiment could be referred to as an ‘enhanced’ Level 3 race car, or even a ‘Level 4’ race car, if desired. One can see, by inspecting FIGS. 14, 17, and 19, that the various computing components of all three versions of these race cars are the same. They all require some computer programming performed on the user's computer 310, and then to have the resulting computer program downloaded into the race car's on-board computer system (i.e., the memory elements (RAM and ROM 346, 344) that operate with the on-board processing circuit, the CPU 342).

As in a Level 2 race car, the software needed to control the Level 3 race car is based on image data from the digital camera 360, but also the Level 3 race car can use the software needed to control the race car based upon multiple line sensors (Level 1). The combination of how to use both types of sensors (in real time) provides a very different challenge to users who may have worked with only a Level 1 or a Level 2 race car. Furthermore, if the optional distance sensors 370 are also used on this (enhanced) Level 3 race car, then the user has yet another programming challenge to deal with, in combining the input data from those distance sensors with the other two types of sensors. All this is by design, to provide a more difficult task for older users.

It will be understood that the array of individual line sensors 350, the line detection camera 360, and the set of distance sensors 370 that are depicted on the hardware block diagram of FIG. 19 correspond to the physical sensors discussed earlier as follows, respectively: the photosensors 56 (line following circuit board sensors), seen on FIGS. 5A and 5B; the computer vision camera S/A 64, seen on FIG. 7A; and the distance sensors 57 (used to detect the barriers 98), mounted on the side pods of chassis 20, seen on FIG. 11.

Software Logic Diagram 3:

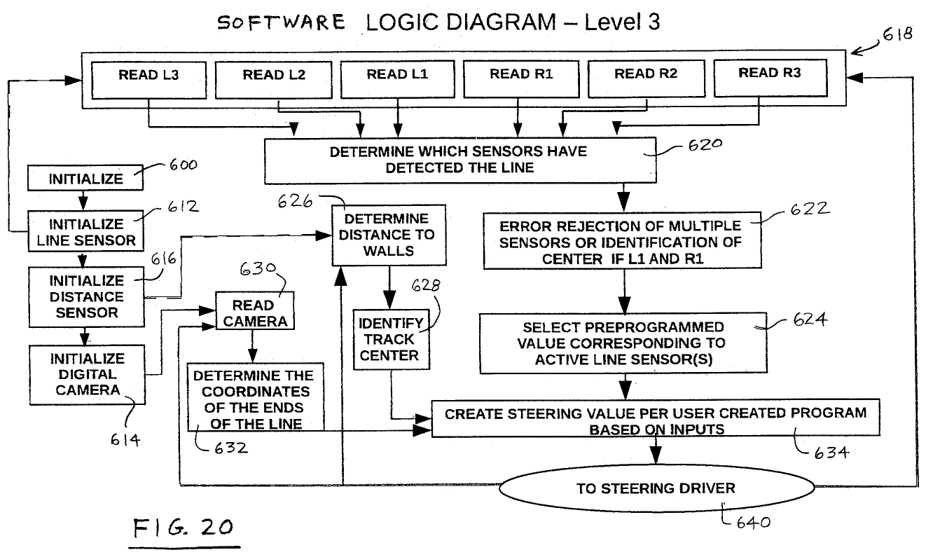

Referring now to FIG. 20, some of the important functions performed by the software logic used by a Level 3 race car are depicted as a flow chart. Starting at an initialization step 600, the processing circuit needs to determine which set of sensors is going to be in effect for this particular model vehicle. In this example, the “Level 3” sensors will be used, which is depicted as a status box 610 on FIG. 20.

In a Level 3 race car, more than one type of sensor is available, and the software needs to be able to interface with each type of sensor that will be used in the computer program that will control the steering of the race car. Therefore, each type of sensor must be initialized so that the sensors (which typically have their own built-in microcontroller) will properly communicate with the CPU 342.

Assuming the line sensors 56 are to be used, they will be initialized at a function step 612. Assuming the digital camera 68 (the ‘line detection camera’ 360) is to be used, it will be initialized at a function step 614. Assuming the distance sensors 57 are to be used, they will be initialized at a function step 616.

In this description, the term ‘initialized’ as pertaining to the sensors, signifies that the (built-in) microcontroller of a particular sensor package will ready itself to communicate with the ‘main’ processing circuit of the race car, i.e., the CPU 342. There are specific communications protocols that must be met, including such basic parameters like the baud rate of the data exchange between processors, and the initialization steps discussed herein for the sensor packages (e.g., steps 612, 614, 616) are used to set those types of parameters. Furthermore, in this description, the term ‘interface with’ signifies that the output signals produced by the various sensors and communicated to the I/O Interface circuit 340, will be signal-conditioned to voltage values that can be read by the CPU 342. Since the photosensors and the ‘distance sensors’ typically produce an analog output signal, those signals must be digitized by an A/D converter that will be found either built into the sensor package itself, or in the I/O Interface circuit 340, or on-board the CPU 342 (assuming that the CPU is a microcontroller chip, or an equivalent ASIC, for example).

After step 612 occurs, the executing software will quickly read the logic states of the various line sensors, at a function step 618. In this example, there are six (6) line sensors, known as “L3”, “L2”, “L1”, “R1”, “R2”, and “R3”, as discussed above in reference to FIG. 13. A ‘read sensors’ function at a step 620 is used to determine which, if any, of those six sensors are detecting a line or stripe (indicia) on the roadway surface that the race car is currently occupying, or about to enter as the car is moving.

As discussed above, an important (but optional) feature is to reject inappropriate input signal states, and to reject inappropriate output commands before such commands are sent to the steering driver circuit. A function step 622 is provided to detect potential multiple sensor ‘line detections’ that may lead to a ‘false’ identification of the center line stripe on the roadway surface. This step 622 operates in a similar fashion to the step 422 that was discussed above for the Level 1 race car.

A function step 624 now is executed to determine the appropriate preprogrammed value that corresponds to the active line sensor detections, just found in the last sampling cycle (in function steps 622 and 624). This output signal value will be used as part of the information that will control the ultimate control signal output value that is to be applied to the physical steering driver circuit 352 (i.e., that controls the steering servo 46). However, there are other input signals to be considered before making that ‘ultimate’ determination.

After step 614 occurs, the executing software will quickly read the pixel values output by the digital camera, at a function step 630. The image values need to be deciphered to determine where, in the image data, a line (or stripe) exists on a roadway surface. A function step 632 is then used to determine the coordinates of the ends of the line (or stripe), if such line has been found in that image data. Step 632 is attempting to determine the coordinates of the roadway surface line (or stripe) that may exist anywhere in the camera's field of vision. The camera is typically looking ‘forward,’ and therefore, the camera's data is attempting to detect a line or stripe (indicia) on the roadway surface that the race car is currently occupying, or is about to enter as the car is moving.

An optional feature to reject inappropriate input signal states, and to reject inappropriate output commands before such commands are sent to the steering driver circuit, could still be used in the Level 3 race car. However, since the image data covers an entire (rectangular) area of space, the ‘coordinate determining function’ of step 632 more or less automatically takes care of ‘finding’ and then ‘rejecting’ false, or ‘phantom’ readings. For example, if the image data for a particular image scan cycle is somehow corrupted, then the ‘coordinate determining function’ of step 632 should simply ‘dump’ that entire image scan cycle and keep using the most recent, previous image data scan until the next non-corrupted scan cycle of image data becomes available. This would occur very quickly in real time, unless of course, some type of hardware failure should occur.

Once the pixel data signals from the camera are ‘processed’ by the function step 632, that information can be used to help determine an appropriate output value that is to be sent to the steering driver circuit. A step 634 is used, first, to receive the ‘recommended’ steering command values that were determined by the steps 624 and 632, and second, to take that accumulated information and to determine an appropriate output value that is to be sent as a signal to the steering driver circuit 352. This determination involves whatever math functions and computer logic instructions that have been programmed by the user into the race car's software that controls the operation of the on-board CPU 342. That signal's output value is then sent to the physical steering driver circuit 352 (i.e., for controlling the steering servo 46) at a function step 640. The steerable wheels of the race car will then be steered accordingly.

If the distance sensors 57 are used, then after step 616 occurs, the executing software will quickly read the signal values output by those distance sensors 57, at a function step 626, to determine the distance between the car's side pods and the race track walls. Using the car's distance from the wall 98 can help the user program the race car to determine where the center of the race surface 96 is. A step 628 is used to help determine more precisely the location of the roadway's center line, with respect to the position of the race car on that roadway surface. This information is then passed on to the step 634 that calculates the ‘ultimate’ steering output commend value.

It will be understood that the executing software for the race car will cycle back to the ‘read’ steps 618 and 630, over and over as needed (in virtual parallel processing, if desired), to constantly update the CPU 342 with the most recent input data, and then to update the output commands to the steering driver circuit 352. These functions must be performed, essentially continuously, until the race car has run over the entire race course, and will probably keep running through their logical operations until power is turned off to the electronics in the race car.

Conclusion on Programming Logic

As noted above, the examples in this description assumed that the roadway surface of the entire race course has only the center line as the roadway surface indicia, and this center line (or stripe) was used on each one of the individual roadway portions. Once users more or less ‘master’ how to run their autonomous race car down that type of race track, then the other indicia patterns of the roadway surfaces can be introduced, which will greatly complicate the programming skill level that will be required to cope with that more complicated race course. Moreover, if side wall are used in most, but not all, portions of the race course, then that feature of the race course will also complicate the use of the distance sensors 57, and that would complicate the programming skill level needed to cope with that variable (in the Level 3 race cars).

This system of both race car design and race track design should provide greater and greater challenges for user programming skills, without requiring any major changes to the physical hardware that is involved. Of course, if certain sensors are left off the race car (e.g., the distance sensors 57), then such a car will be unable to use that type of input information until those sensors are eventually installed. But all the sensors are easy to install, and/or remove, using the race car design disclosed herein.

It will be understood that the logical operations described in relation to the flow charts of FIGS. 15, 18, and 20 can be implemented using sequential logic (such as by using microprocessor technology), or using a logic state machine, or perhaps by discrete logic; it even could be implemented using parallel processors. One preferred embodiment may use a microprocessor or microcontroller (e.g., CPU 342) to execute software instructions that are stored in memory cells within an ASIC. In fact, an entire microprocessor (and microcontroller, for that matter), along with RAM and executable ROM, may be contained within a single ASIC, in one mode of the technology disclosed herein. Of course, other types of circuitry could be used to implement these logical operations depicted in the drawings without departing from the principles of the technology disclosed herein. In any event, some type of processing circuit will be provided, whether it is based on a microprocessor, a microcomputer, a microcontroller, a logic state machine, by using discrete logic elements to accomplish these tasks, or perhaps by a type of computation device not yet invented; moreover, some type of memory circuit will be provided, whether it is based on typical RAM chips, EEROM chips (including Flash memory), by using discrete logic elements to store data and other operating information (such as the user-generated computer program stored, for example, in memory circuit of the race car, in RAM 346 and/or ROM 344), or perhaps by a type of memory device not yet invented. In general, the memory circuit of a particular electronic product will contain instructions that are executable by the processing circuit of that same particular electronic product.

It will also be understood that the precise logical operations depicted in the flow charts of FIGS. 15, 18, and 20, and discussed above, could be somewhat modified to perform similar, although perhaps not exact, functions without departing from the principles of the technology disclosed herein. The exact nature of some of the decision steps and other commands in these flow charts are directed toward specific future model race car kits (those involving microprocessor-controlled autonomous-steering cars, for example) and certainly similar, but somewhat different, steps would be taken for use with other models or brands of race car kits or systems in many instances, with the overall inventive results being the same.

Additionally, it will be understood that a computing product that includes a display to show information to a human user, and that also includes a “user operated input circuit” so the human user is able to enter commands or data, can be provided with a single device that is known as a “touchscreen display.” In other words, if a patent claim recites a “display” and a “user operated input circuit” as two separate elements, then a single touchscreen display, in actually, is exactly the same thing. It should be noted that a touchscreen display usually includes a virtual keypad, and therefore, a “user operated input circuit” typically comprises a virtual keypad, particularly on smart phones and on tablet computers. Moreover, in this situation, the word “virtual” means that it is not a hardware keypad; more specifically, “virtual” means that it is formed (i.e., “created”) on the display screen because of software being executed by a processing circuit.

It will be further understood that any type of product described herein that has moving parts, or that performs functions (such as computers with processing circuits and memory circuits), should be considered a “machine,” and not merely as some inanimate apparatus. Such “machine” devices should automatically include power tools, printers, electronic locks, and the like, as those example devices each have certain moving parts. Moreover, a computerized device that performs useful functions should also be considered a machine, and such terminology is often used to describe many such devices; for example, a solid-state telephone answering machine may have no moving parts, yet it is commonly called a “machine” because it performs well-known useful functions.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two male and female structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two male and female structures actually touch one another along a continuous surface. Or, two structures of any size and shape (whether male, female, or otherwise in shape) may be located somewhat near one another, regardless if they physically abut one another or not; such a relationship could still be termed “proximal” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

1. A race car kit comprising:
a chassis, at least one steerable wheel, a processing circuit, a memory circuit including instructions executable by said processing circuit, an input/output interface circuit, an output actuator for controlling said at least one steerable wheel, and at least one roadway detection sensor;
wherein:
(a) said processing circuit is configured to execute the instructions stored in said memory circuit, and said instructions stored in the memory circuit involve a level of programming difficulty from at least two possible levels of programming difficulty, such that a first algorithm is provided for a first level of programming difficulty and a second algorithm is provided for a second level of programming difficulty;
(b) said first algorithm stored in the memory circuit is used for controlling said output actuator, based on input data received from a first type of said at least one roadway detection sensor; and
(c) said second algorithm stored in the memory circuit is used for controlling said output actuator, based on input data received from a second type of said at least one roadway detection sensor.

2. The race car kit of claim 1, wherein, said first algorithm performs functions of:
(a) receiving input data from said at least one roadway detection sensor; and
(b) selecting at least one numeric value to be used as an output guidance command signal to control said output actuator, based upon a result of said received input data.

3. The race car kit of claim 2, wherein:
said at least one roadway detection sensor comprises a plurality of photosensors.

4. The race car kit of claim 3, wherein:
said plurality of photosensors act as line following sensors.

5. The race car kit of claim 1, wherein, said second algorithm performs functions of:
(a) interpreting image data received as input data from a computer vision camera;
(b) determining a position of roadway surface indicia, based upon said received image data; and
(c) selecting at least one numeric value to be used as an output guidance command signal to control said output actuator.

6. The race car kit of claim 5, wherein:
said function of determining a position of roadway surface indicia is used to find the ends of stripes that comprise said roadway surface indicia.

7. The race car kit of claim 6, wherein:
said computer vision camera comprises a digital camera.

8. The race car kit of claim 1, further comprising:
(a) a third algorithm that is provided for a third level of programming difficulty; and
(b) said third algorithm is used for controlling said output actuator, based on input data received from a both said first type of said at least one roadway detection sensor, and said second type of said at least one roadway detection sensor.

9. The race car kit of claim 8, wherein:
(a) said first type of said at least one roadway detection sensor comprises a plurality of photosensors; and
(b) said second type of said at least one roadway detection sensor comprises a computer vision camera.

10. The race car kit of claim 8, further comprising:
(a) a third type of said at least one roadway detection sensor; and
(b) said third algorithm also uses input data received from said third type of roadway detection sensor.

11. The race car kit of claim 10, wherein:
(a) said third type of said at least one roadway detection sensor comprises a proximity distance sensor; and
(b) said proximity distance sensor is used to detect a distance from said race car kit to a barrier along at least one side of the roadway.

12. A race car kit comprising:
a chassis, at least one steerable wheel, a processing circuit, a memory circuit including instructions executable by said processing circuit, an input/output interface circuit which includes a communications interface circuit, an output actuator for controlling said at least one steerable wheel, and at least one roadway detection sensor;
wherein:
(a) said processing circuit is configured to execute the instructions stored in said memory circuit; and
(b) said instructions stored in the memory circuit include at least one of:
(i) a first algorithm for controlling said output actuator involving a first level of programming difficulty, such that:
(A) at least one predetermined type of input parameter is provided by a user by use of said communications interface circuit, and stored in said memory circuit; and
(B) said first algorithm controls the acquisition of sensor data and, using said at least one user-provided input parameter, controls said output actuator;
and
(ii) a second algorithm for controlling said output actuator involving a second, more difficult level of programming difficulty, such that:
(A) said second algorithm is provided by a user by use of said communications interface circuit, and stored in said memory circuit; and
(B) said second algorithm controls the acquisition of sensor data and, by itself, controls said output actuator.

13. The race car kit of claim 12, wherein:
(a) said first algorithm is partially provided by a first person who provides the unassembled kit; and
(b) a second person provides numeric values that are used to complete said first algorithm, which is then stored as said instructions in said memory circuit.

14. The race car kit of claim 13, wherein, said first algorithm performs functions of:
(a) receiving input data from said at least one roadway detection sensor; and
(b) selecting at least one numeric value to be used as an output guidance command signal to control said output actuator, based upon a result of said received input data.

15. The race car kit of claim 14, wherein:
said at least one roadway detection sensor comprises a plurality of photosensors.

16. The race car kit of claim 12, wherein:
(a) said second algorithm is completely provided by a user, and the second algorithm is stored as said instructions in said memory circuit.

17. The race car kit of claim 16, wherein, said second algorithm performs functions of:
(a) interpreting image data received as input data from a computer vision camera;
(b) determining a position of roadway surface indicia, based upon said received image data; and
(c) selecting at least one numeric value to be used as an output guidance command signal to control said output actuator.

18. The race car kit of claim 17, wherein:
said function of determining a position of roadway surface indicia is used to find the ends of stripes that comprise said roadway surface indicia.

19. The race car kit of claim 18, wherein:
said computer vision camera comprises a digital camera.

20. The race car kit of claim 12, further comprising:
(a) a third algorithm for controlling said output actuator involving a third, more difficult level of programming difficulty, such that:
(i) said third algorithm is provided by a user by use of said communications interface circuit, and stored in said memory circuit; and
(ii) said second algorithm controls the acquisition of sensor data and, by itself, controls said output actuator; and
(b) said third algorithm performs functions of: controlling said output actuator, based on input data received from a both said first type of said at least one roadway detection sensor, and said second type of said at least one roadway detection sensor.

21. The race car kit of claim 20, wherein:
(a) said first type of said at least one roadway detection sensor comprises a plurality of photosensors; and
(b) said second type of said at least one roadway detection sensor comprises a computer vision camera.

22.-65. (canceled)
